(19) United States
(12) Patent Application Publication
(10) Pub. No.: US 2015/0256407 A1
(43) Pub. Date: Sep. 10, 2015

(54) CONTROL APPARATUS, CONTROL METHOD THEREOF, AND PROGRAM

(71) Applicant: NEC CORPORATION, Tokyo (JP)

(72) Inventors: Yohei Iizawa, Tokyo (JP); Yohei Hasegawa, Tokyo (JP)

(21) Appl. No.: 14/433,011

(22) PCT Filed: Oct. 2, 2013
(86) PCT No.: PCT/JP2013/005884

§ 371 Date: Apr. 1, 2015

(30) Foreign Application Priority Data
Oct. 3, 2012 (JP) 2012-221481

(51) Int. Cl. H04L 12/24

(52) U.S. Cl. CPC H04L 41/12; H04L 41/0803

(57) ABSTRACT

A control apparatus controls a hierarchized network and generates a topology in a second layer different from a first layer based on an operation policy for the network and paths in the first layer of the network.

### TECHNICAL FIELD

### Reference to Related Application

The present invention is based upon and claims the benefit of the priority of Japanese patent application No. 2012-221481, filed on Oct. 3, 2012, the disclosure of which is incorporated herein in its entirety by reference thereto.

The present invention relates to a control apparatus, a control method thereof, and a program. In particular, it relates to: a control apparatus controlling a hierarchized network in a central manner; a control method of the control apparatus; and a program.

### BACKGROUND

In recent years, a technique referred to as OpenFlow has been proposed (see non patent literature (NPL) 1 and 2). OpenFlow recognizes communications as end-to-end flows and performs path control, failure recovery, load balancing, and optimization on a per-flow basis. An OpenFlow switch according to NPL 2 has a secure channel for communication with an OpenFlow controller and operates according to a flow table suitably added or rewritten by the OpenFlow controller. In a flow table, a set of the following three is defined for each flow: matching conditions (Match Fields) against which a packet header is matched; flow statistical information (Counters); and Instructions that define processing contents (see section “4.1 Flow Table” in NPL 2).

For example, when receiving a packet, the OpenFlow switch searches the flow table for an entry having a matching condition (see “4.3 Match Fields” in NPL 2) that matches header information of the incoming packet. If, as a result of the search, the OpenFlow switch finds an entry matching the incoming packet, the OpenFlow switch updates the flow statistical information (Counters) and processes the incoming packet based on a processing content (packet transmission from a specified port, flooding, drop, etc.) written in the Instructions field of the entry. If, as a result of the search, the OpenFlow switch does not find an entry matching the incoming packet, the OpenFlow switch transmits an entry setting request (Packet-In message) to the OpenFlow controller via the secure channel. Namely, the OpenFlow switch requests the OpenFlow controller to transmit control information for processing the incoming packet. The OpenFlow switch receives a flow entry defining a processing content and updates the flow table. In this way, by using an entry stored in the flow table as control information, the OpenFlow switch executes packet forwarding.

PTL 1 discloses an optical network system including: a plurality of optical edge routers each of which includes an optical path establishing means and connects an external IP network to an optical network; and a plurality of optical cross-connect apparatuses each of which includes a switching means per optical path for connecting optical edge routers by using an optical path.

### CITATION LIST

### Patent Literature

### [PTL 1]

International Publication No. 2004/071033

### Non Patent Literature

### [NPL 1]

Nick McKeown and seven others, “OpenFlow: Enabling Innovation in Campus Networks,” [online], [searched on Jul. 13, 2012], Internet <URL:http://www.openflow.org/documents/openflow-wp-latest.pdf>

### [NPL 2]

“OpenFlow Switch Specification” Version 1.1.0 Implemented (Wire Protocol 0x02), [online], [searched on Jul. 13, 2012], Internet <URL:http://www.openflow. org/documents/openflow-spec-v1.1.0.pdf>

### SUMMARY

### Technical Problem

The disclosures of all the literature in the above citation list are incorporated herein by reference thereto. The following analysis has been given by the present invention.

A hierarchized network can roughly be divided into an upper layer realized by apparatuses such as routers and a lower layer realized by apparatuses for realizing links in the upper layer (for example, optical cross-connects and the like). Since such optical cross-connects and the like are apparatuses for realizing links in the upper layer, a network administrator normally determines paths in the lower layer by estimating bandwidths or the like required by the links in the upper layer.

In contrast, in many cases, apparatuses such as routers determine a topology in the upper layer by using a routing protocol such as OSPF (Open Shortest Path First) or BGP (Border Gateway Protocol) and causing neighboring communication nodes to exchange information.

In addition, in recent years, in many cases, various services have been provided by using a single network and a single network is used by various users. In such circumstances, there is a strong demand to change the topology in the upper layer in accordance with a certain service or user.

However, in a hierarchized network, it is difficult to change the upper layer topology in accordance with packets or the like relating to a certain service. In a hierarchized network, in many cases, the upper and lower layers are managed and controlled separately. Thus, in such network, it is difficult to process packets relating to a certain service separately from packets relating to other services, for example. This is because, even if packets relating to a certain service are detected in the upper layer, paths in the lower layer for forwarding the packets cannot appropriately be selected. For example, even if an apparatus in the upper layer attempts to forward packets relating to a certain service or the like at a predetermined bandwidth or more, there is no means of realizing switching of corresponding paths.

By adding functions equivalent to those of an OpenFlow switch in NPL 1 and 2 to the optical cross-connects and optical edge routers in PTL 1, an optical IP network capable of performing path control with fine granularity can be established. However, even if the technique disclosed in PTL 1 is applied, the apparatuses in the upper layer cannot appropriately select paths in the lower layer.

In view of such circumstances, it is an object of the present invention to provide: a control apparatus that can generate a topology in an upper layer in accordance with a requirement for a network managed by the control apparatus such as an OpenFlow controller in NPL 1 and 2; a control method of the control apparatus; and a program.

### Solution to Problem

According to a first aspect of the present invention, there is provided a control apparatus controlling a hierarchized network and generating a topology in a second layer different from a first layer based on an operation policy for the network and paths in the first layer of the network.

According to a second aspect of the present invention, there is provided a method of controlling a control apparatus controlling a hierarchized network, the method comprising: receiving an operation policy for the network; and generating a topology in a second layer different from a first layer based on the operation policy and paths in the first layer in the network.

This method is associated with a certain machine, that is, with the control apparatus controlling the hierarchized network.

According to a third aspect of the present invention, there is provided a program causing a computer, which constitutes a control apparatus that controls a hierarchized network, to execute processes of: receiving an operation policy for the network; and generating a topology in a second layer different from a first layer based on the operation policy and paths in the first layer in the network.

This program can be recorded in a computer-readable storage medium. The storage medium may be a non-transient medium such as a semiconductor memory, a hard disk, a magnetic recording medium, or an optical recording medium. The present invention can be embodied as a computer program product.

### Advantageous Effects of Invention

According to the above aspects of the present invention, there are provided: a control apparatus that can generate a topology in an upper layer in accordance with a requirement for a network managed by the control apparatus; a control method of the control apparatus; and a program.

### BRIEF DESCRIPTION OF DRAWINGS

FIG. 1 illustrates an outline of an exemplary embodiment.

FIG. 2 illustrates an outline of an exemplary embodiment.

FIG. 3 illustrates a communication system according to a first exemplary embodiment.

FIG. 4 illustrates a communication system including transport nodes realizing links among edge nodes.

FIG. 5 illustrates an internal configuration of an edge node 10.

FIG. 6 illustrates a table set in a table DB 13 of an edge node 10-1.

FIG. 7 illustrates an internal configuration of a transport node 40.

FIG. 8 illustrates an internal configuration of a control apparatus 20.

FIG. 9 illustrates upper layer link information.

FIG. 10 illustrates packet forwarding information.

FIG. 11 illustrates connection of ports of the edge node 10-1 and a transport node 40-1.

FIG. 12 illustrates physical layer configuration information.

FIG. 13 illustrates an operation policy inputted by a network administrator.

FIG. 14 illustrates a topology in a lower layer previously determined by a network administrator.

FIG. 15 is a table representing details of nine optical paths in FIG. 14.

FIG. 16 illustrates a topology in an upper layer.

FIG. 17 is a flowchart illustrating an operation of the control apparatus 20.

FIG. 18 is a flowchart illustrating link calculation performed by an upper layer topology generation unit 204.

FIG. 19 illustrates a topology in the upper layer generated by link calculation.

FIG. 20 illustrates a packet handling operation (processing rule) set in the edge node 10-1.

FIG. 21 illustrates a packet handling operation set in the transport node 40-1.

FIG. 22 illustrates an operation policy.

FIG. 23 illustrates a topology in the upper layer generated by link calculation.

FIG. 24 illustrates an operation policy.

FIG. 25 illustrates an operation policy.

FIG. 26 illustrates a topology in the upper layer generated by link calculation.

FIG. 27 illustrates an operation policy.

FIG. 28 illustrates a topology in the upper layer generated by link calculation.

FIG. 29 illustrates an operation policy.

FIG. 30 illustrates a topology in the upper layer generated by link calculation.

FIG. 31 is a flowchart illustrating an operation of the upper layer topology generation unit 204.

FIG. 32 illustrates a topology in the lower layer.

FIG. 33 illustrates a topology in the upper layer generated by link calculation.

### DESCRIPTION OF EMBODIMENTS

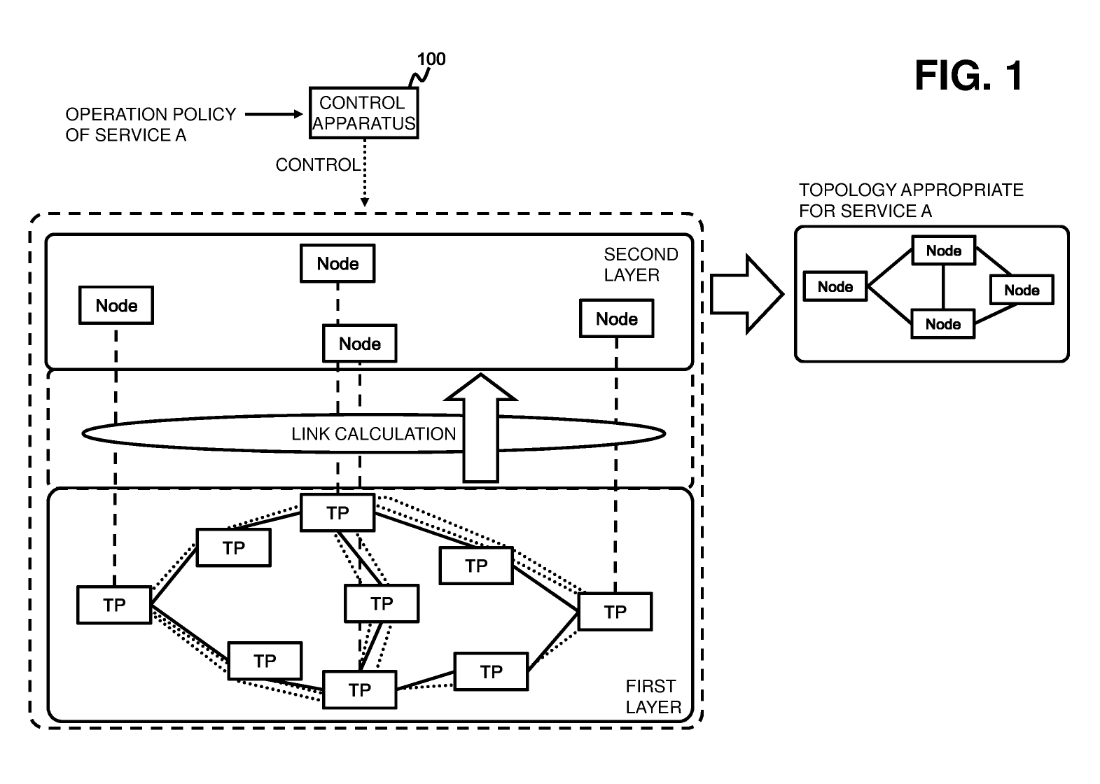

First, an outline of an exemplary embodiment will be described with reference to FIG. 1. In the following outline, various components are denoted by reference characters for the sake of convenience. Namely, the following reference characters are merely used as examples to facilitate understanding of the present invention. Thus, the present invention is not limited to the description of the following outline.

As described above, in a hierarchized network, in many cases, the upper and lower layers are managed and controlled separately. Thus, in such hierarchized network, it is difficult to change a network configuration in accordance with a service or the like required of the network. Therefore, there is demand for a control apparatus that generates an upper layer topology in accordance with a requirement for the hierarchized network.

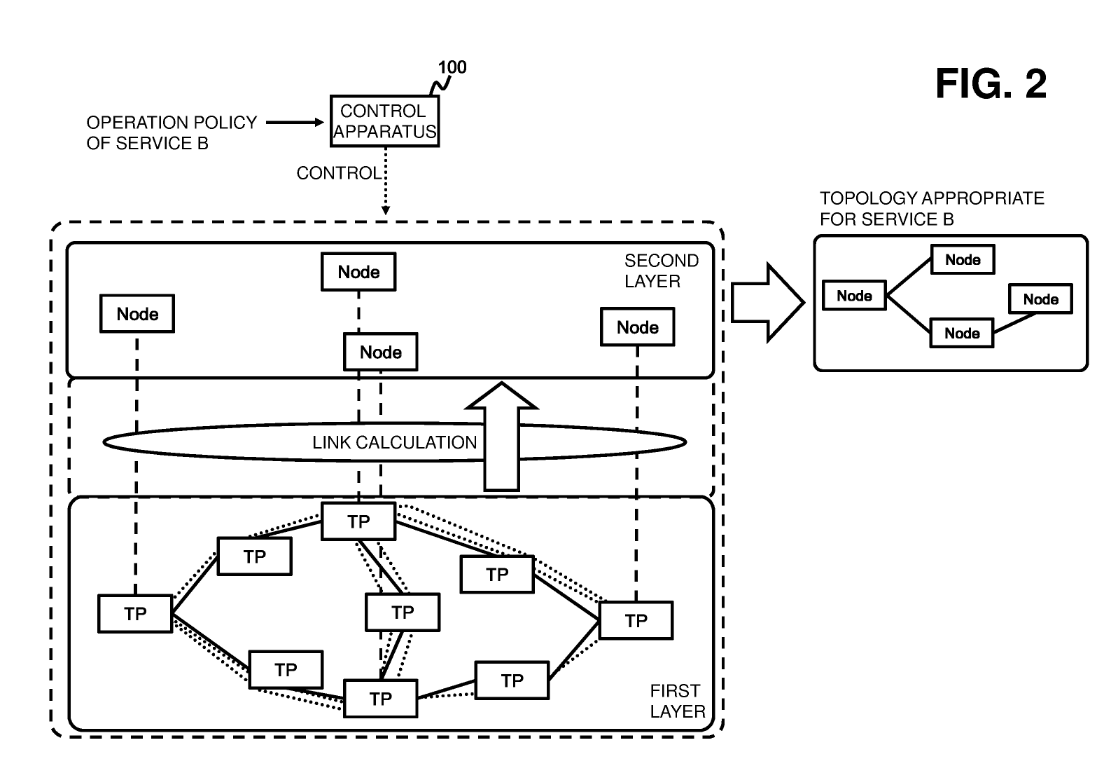

In response, as an example, a control apparatus 100 is provided (see FIG. 1 or 2). The control apparatus 100 controls a hierarchized network and generates a topology in a second layer different from a first layer based on an operation policy for the network and paths of the first layer in the network.

The control apparatus 100 controls a hierarchized network that includes at least the first and second layers. In this network controlled by the control apparatus 100, the first layer is relatively lower in hierarchy than the second layer. When operating the network, a network administrator determines a topology in the first layer. Namely, the network administrator operates the network by using paths in the first layer forming links in the second layer. In addition, the network administrator inputs a policy(ies) for operating the network to the control apparatus 100. For example, for each service provided by the network, an operation policy includes a requirement relating to characteristics of a linkage (link or links) in the second layer. Examples of the characteristics of a second layer link include information about the bandwidth, delay, or jitter of the link and information about redundant links.

Based on an operation policy inputted by the network administrator and paths in the first layer previously determined, the control apparatus 100 generates a second layer topology that can satisfy the requirement(s) of the operation policy. In other words, the control apparatus 100 generates an upper layer topology by selecting paths appropriate for the operation policy from the first layer paths forming the links in the second layer. Processing performed by the control apparatus 100 to generate such upper layer topology will hereinafter be referred to as link calculation. For example, if an operation policy relating to a service A is inputted to the control apparatus 100, the control apparatus 100 generates a second layer topology appropriate for the service A (see FIG. 1). If an operation policy relating to a service B is inputted to the control apparatus 100, the control apparatus 100 generates a second layer topology appropriate for the service B (see FIG. 2).

If services are different, specifications required for the network providing the services are different. Thus, for each service, operation policy (or policies) needs to specifically define what is required (specifications) for the links in the second layer of the network that provides the services. The control apparatus 100 determines a second layer topology by selecting first layer paths that are sufficient for realizing the specifications defined in the corresponding operation policy. Namely, the control apparatus 100 can generate an upper layer topology in accordance with a requirement for a hierarchized network.

Next, specific embodiments will be described in more detail with reference to the drawings.

### First Exemplary Embodiment

A first exemplary embodiment will be described in details with reference to drawings.

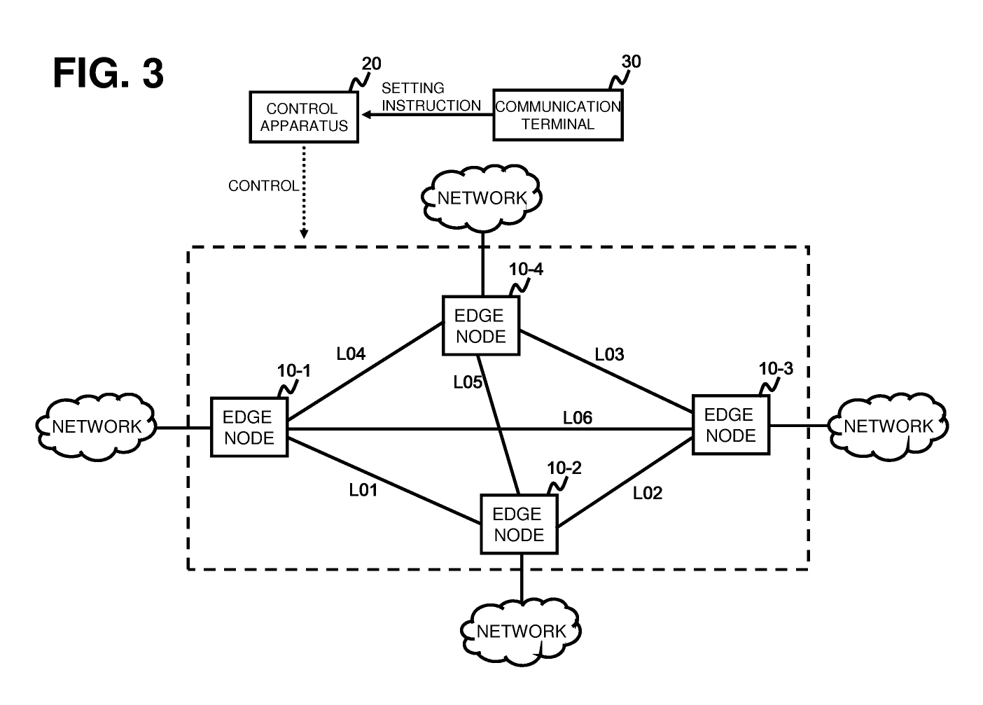

FIG. 3 illustrates a communication system according to the first exemplary embodiment. FIG. 3 illustrates a configuration including edge nodes (ENs) 10-1 to 10-4 realizing connection in a network, a control apparatus 20 controlling the network including the edge nodes 10-1 to 10-4, and a communication terminal 30 used by a network administrator. For example, the control apparatus 20 corresponds to an OpenFlow controller and the edge nodes 10-1 to 10-4 correspond to OpenFlow switches.

The network administrator uses the communication terminal 30 to perform various settings on the control apparatus 20 and to maintain and manage the network including the edge nodes 10-1 to 10-4.

Hereinafter, the names of the links among the edge nodes will be determined as illustrated in FIG. 3. Specifically, the links among the edge nodes and the names of the links will be referred to as follows:

A link L01 represents a link between the edge nodes 10-1 and 10-2.
A link L02 represents a link between the edge nodes 10-2 and 10-3.
A link L03 represents a link between the edge nodes 10-3 and 10-4.
A link L04 represents a link between the edge nodes 10-4 and 10-1.
A link L05 represents a link between the edge nodes 10-2 and 10-4.
A link L06 represents a link between the edge nodes 10-1 and 10-3.

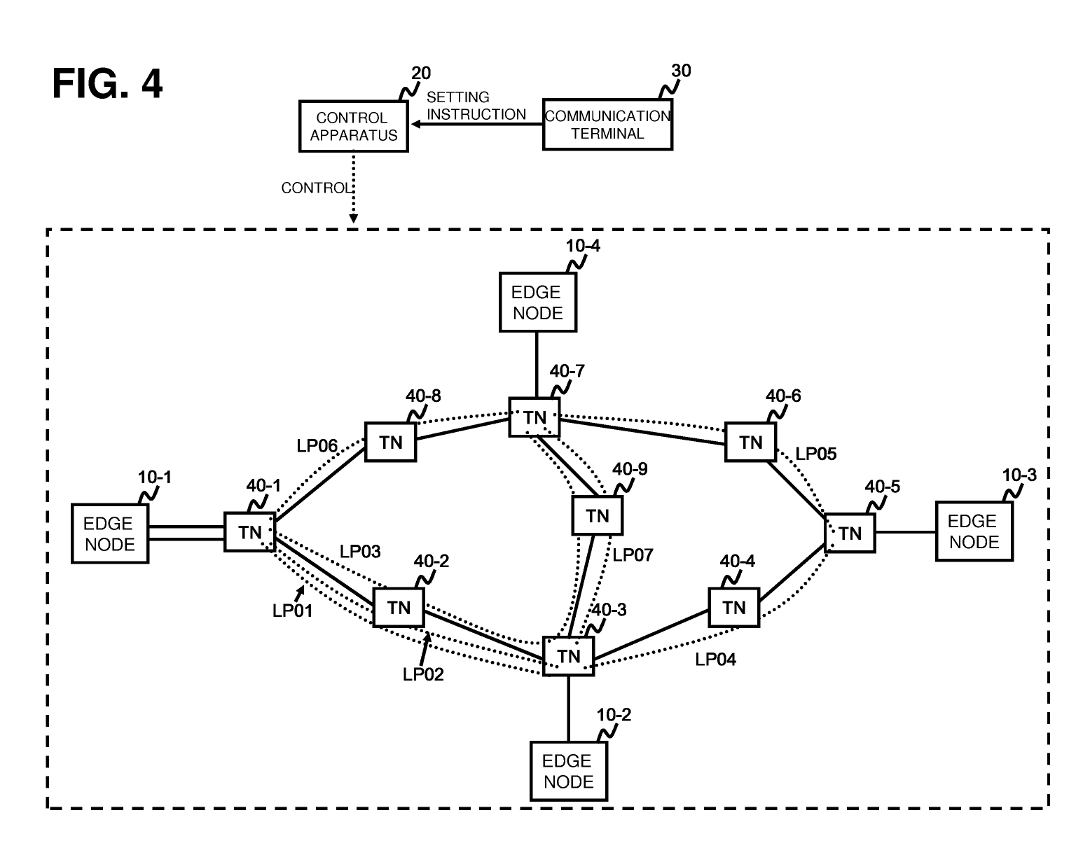

FIG. 4 illustrates a communication system including transport nodes (TNs) realizing links among the edge nodes. In FIG. 4, transport nodes 40-1 to 40-9 realize the links among the edge nodes. For example, the transport nodes 40-1 to 40-9 are connected to each other by physical cables or lower-layer paths and correspond to packet transport nodes (PTNs) that set packet paths and perform packet communication. For example, Multi-Protocol Label Switching Transport Profile (MPLS-TP) can be used as a technique applicable to communication relating to the packet transport nodes. In addition, for example, the packet paths correspond to Label Switched Path (LSP) or Pseudo Wire (PW).

Alternatively, for example, the transport nodes 40-1 to 40-9 are connected to each other by optical fiber cables and correspond to optical cross-connects (OXCs) realizing forwarding of optical data. The present exemplary embodiment will be described assuming that the transport nodes 40-1 to 40-9 are optical cross-connects realizing forwarding of optical data.

In the following description, the layer realized by connecting the edge nodes 10-1 to 10-4 to each other will be referred to as an upper layer and the layer realized by connecting the transport nodes 40-1 to 40-9 to each other will be referred to as a lower layer. The above first layer corresponds to the lower layer and the second layer corresponds to the upper layer. In addition, the edge nodes 10-1 to 10-4 will be referred to as “the edge nodes 10” unless no particular distinction needs to be made. Likewise, the transport nodes 40-1 to 40-9 will be referred to as the “transport nodes 40” unless no particular distinction needs to be made.

As described above, the links among the edge nodes 10-1 to 10-4 are realized by connecting the plurality of transport nodes 40-1 to 40-9 to each other. In a network illustrated in FIG. 4, seven optical paths (LP01 to LP07) are illustrated as the optical paths realizing the links among the edge nodes 10-1 to 10-4. In FIG. 4, the solid lines among the transport nodes represent the optical fiber cables and the dotted lines represent the optical paths. In FIG. 4, for example, the optical path LP01 connects the transport nodes 40-1 and 40-3. The optical path LP07 connects the transport nodes 40-3 and 40-7.

To operate the network, a network administrator previously determines information that defines which nodes in the lower layer are connected to which link. Namely, a network administrator previously determines a lower layer topology. The network administrator inputs the lower layer topology to the control apparatus 20 via the communication terminal 30.

The control apparatus 20 stores information about physical configurations of apparatus and cables included in the network. In the following description, the information about physical configurations stored in the control apparatus 20 will be referred to as “physical layer configuration information.” Prior to a network operation, the network administrator inputs the physical layer configuration information to the control apparatus 20. Alternatively, the control apparatus 20 may generate the physical layer configuration information by collecting information from each node included in the control target network.

The network administrator inputs information to the control apparatus 20 based on policies used when the network is operated. For example, for a certain service provided by using the network illustrated in FIG. 3, the network administrator inputs a setting that ensures a sufficient bandwidth to the control apparatus 20. Alternatively, for another service using the network, the network administrator inputs a setting requiring that a delay among the edge nodes 10-1 to 10-4 is a predetermined value or less.

The control apparatus 20 generates an upper layer topology, based on paths in the lower layer and an operation policy including specifications required by the network administrator. More specifically, the control apparatus 20 generates an upper layer topology, by selecting paths satisfying the specifications required by the operation policy from a group of paths in the lower layer forming the links in the upper layer.

If the network administrator inputs a different operation policy to the control apparatus 20, different link calculation results are obtained. Thus, the control apparatus 20 performs link calculation and stores the result thereof (upper layer topology) per operation policy. The control apparatus 20 associates an operation policy with a corresponding upper layer topology generated by link calculation and stores the associated data. The network administrator may previously input such an operation policy before a network operation is started. Alternatively, the control apparatus 20 may sequentially input an operation policy, as needed.

When the control apparatus 20 performs link calculation, paths appropriate for the operation policy are selected from the optical paths in the lower layer that are previously inputted by the network administrator (from the optical paths forming the links in the upper layer). The control apparatus 20 sets packet handling operations (i.e., processing rules) realizing the optical paths selected based on the upper layer and the link calculation in the relevant edge nodes 10 and transport nodes 40. The edge nodes 10 and transport nodes 40 process (forward) packets in accordance with the respective packet handling operation set by the control apparatus 20. Namely, the control apparatus 20 generates packet handling operations to be set in the edge nodes 10 and transport nodes 40, based on results of the link calculation.

If any one of the edge nodes 10 and transport nodes 40 does not have a packet handling operation matching the match field of an incoming packet, the edge node 10 or transport node 40 queries the control apparatus 20 about processing performed on the incoming packet. When receiving the query, the control apparatus 20 calculates a packet handling operation corresponding to the incoming packet and sets the packet handling operation in the edge node 10 or transport node 40.

As described above, in the communication system according to the present exemplary embodiment, the edge nodes 10 and the transport nodes 40 are controlled by the control apparatus 20.

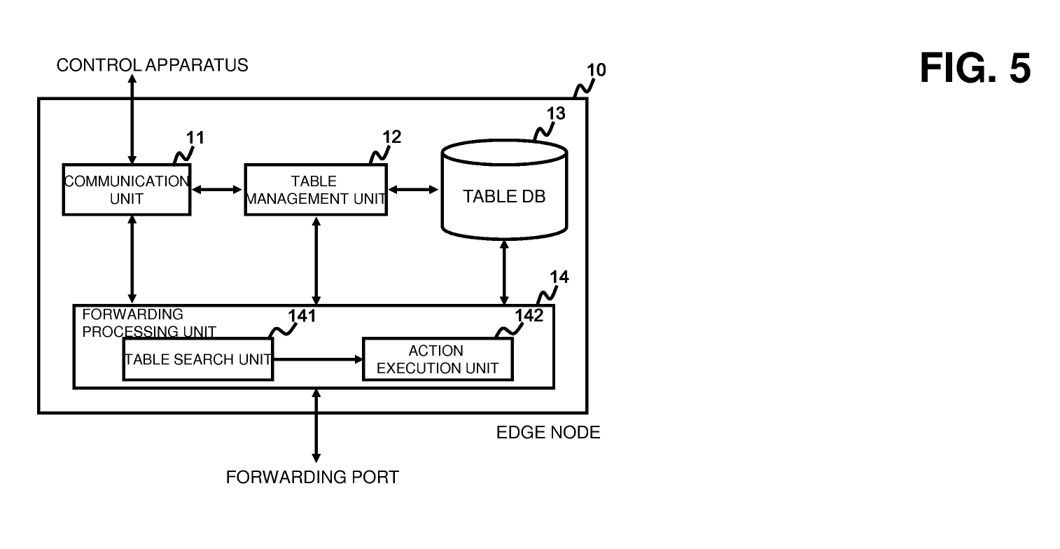

FIG. 5 illustrates an internal configuration of an edge node 10. The edge node 10 includes a communication unit 11, a table management unit 12, a table database (table DB) 13, and a forwarding processing unit 14.

The communication unit 11 is a means of communicating with the control apparatus 20 that sets a packet handling operation in the edge node 10. In the present exemplary embodiment, the communication unit 11 uses the OpenFlow protocol in NPL 2 to communicate with the control apparatus 20. However, the communication protocol used between the communication unit 11 and the control apparatus 20 is not limited to the OpenFlow protocol.

The table management unit 12 is a means of managing the tables stored in the table DB 13. More specifically, the table management unit 12 registers a packet handling operation instructed by the control apparatus 20 in the table DB 13. When notified of reception of a new packet by the forwarding processing unit 14, the table management unit 12 requests the control apparatus 20 to set a packet handling operation. In addition, if the expiration condition in a packet handling operation stored in a table is satisfied, the table management unit 12 performs processing for deleting or invalidating the packet handling operation.

The table DB 13 is configured by a database that can store at least one table to which the forwarding processing unit 14 refers when processing an incoming packet.

The forwarding processing unit 14 includes a table search unit 141 and an action execution unit 142. The table search unit 141 is a means of searching the tables stored in the table DB 13 for a packet handling operation having a match field matching an incoming packet. The action execution unit 142 is a means of processing packets in accordance with a processing content indicated in the instruction field of a packet handling operation found by the table search unit 141.

If the forwarding processing unit 14 does not find a packet handling operation having a match filed matching an incoming packet, the forwarding processing unit 14 notifies the table management unit 12 to that effect. In addition, depending on the packet processing, the forwarding processing unit 14 updates statistical information registered in the table DB 13.

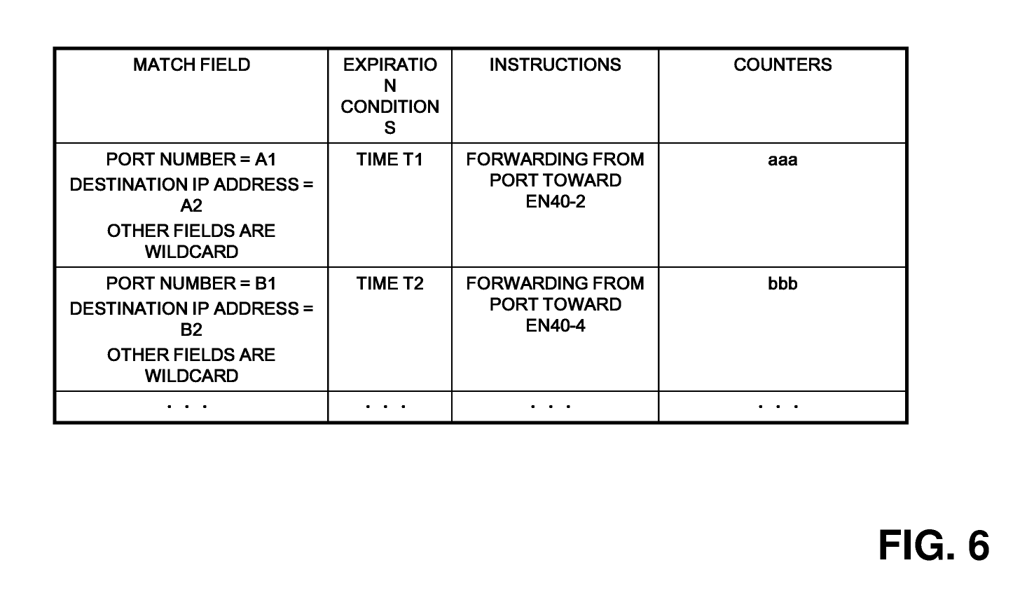

FIG. 6 illustrates a table set in the table DB 13 of the edge node 10-1. In FIG. 6, packet handling operations for forwarding incoming packets that are received by the edge node 10-1 to the edge nodes 10-2 and 10-4 are set. For example, if the edge node 10-1 receives a packet indicating that the port number is A1 and the destination IP address is A2, the edge node 10-1 performs the top packet handling operation in FIG. 6.

If the edge node 10-1 receives an incoming packet (port number=A1 and destination IP address=A2), the table search unit 141 of the edge node 10-1 finds the top packet handling operation in the table in FIG. 6 as the packet handling operation matching the incoming packet. In accordance with the content indicated in the instruction field of the packet handling operation, the action execution unit 142 of the edge node 10-1 forwards the incoming packet to the edge node 10-2. Likewise, if the edge node 10-1 receives a packet indicating that the port number is B1 and the destination IP address is B2, the edge node 10-1 forwards the packet to the edge node 10-4. If the edge node 10 does not have a packet handling operation corresponding to an incoming packet, the edge node 10 requests the control apparatus 20 to set a packet handling operation.

In addition, in FIG. 6, time T1 and time T2 are set as Time To Live (TTL) in the expiration conditions of the packet handling operations, respectively. For example, if the top packet handling operation in FIG. 6 is not performed for the time T1, the table management unit 12 performs an operation of deleting this packet handling operation. The forwarding processing unit 14 initializes a TTL management timer each time a packet handling operation is performed. Each time a packet handling operation is performed, the statistical information in the packet handling operation is updated. Similar packet handling operations as described above are set in the edge nodes 10-2 to 10-4 as well.

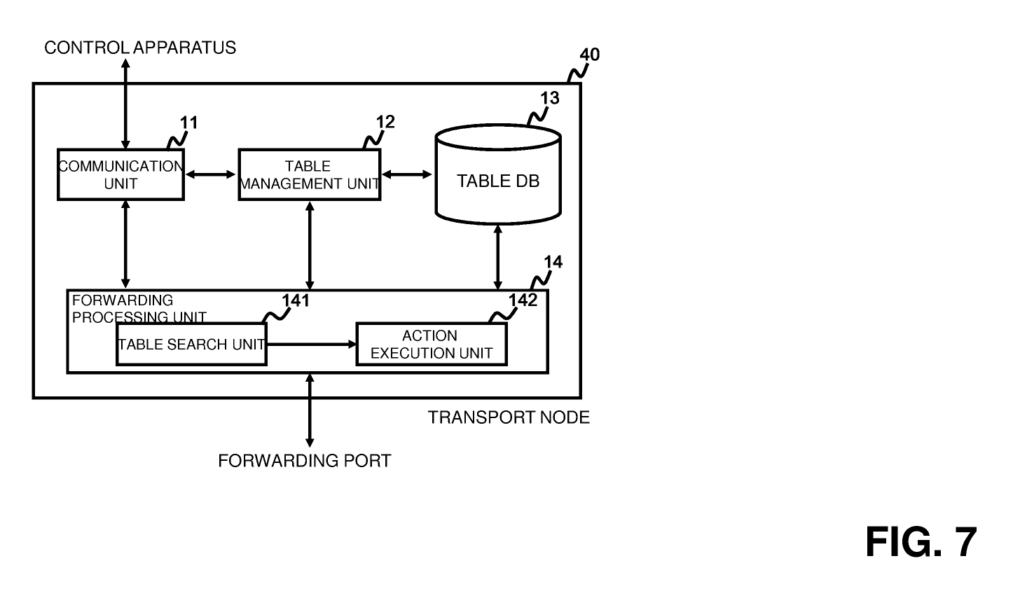

FIG. 7 illustrates an internal configuration of a transport node 40. A main internal configuration of the transport node 40 matches that of the edge node 10 illustrated in FIG. 5. Thus, further description of the internal configuration of the transport node 40 will be omitted. The edge node 10 and the transport node 40 are different in that different contents are registered in the respective table DBs 13. If packet handling operations registered in the respective table DBs 13 are different, the respective action execution units 142 perform different packet processing in accordance with the respective packet handling operations.

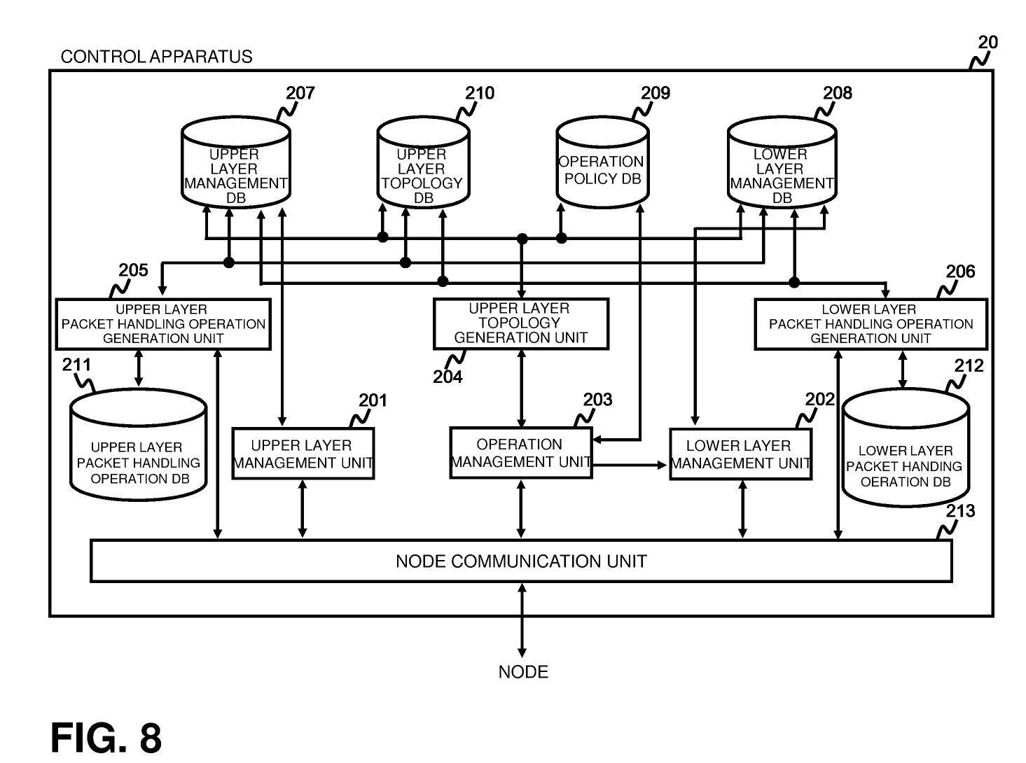

FIG. 8 is a block diagram illustrating a configuration of the control apparatus 20. The control apparatus 20 includes an upper layer management unit 201, a lower layer management unit 202, an operation management unit 203, an upper layer topology generation unit 204, an upper layer packet handling operation generation unit 205, a lower layer packet handling operation generation unit 206, an upper layer management database (upper layer management DB) 207, a lower layer management database (lower layer management DB) 208, an operation policy database (operation policy DB) 209, an upper layer topology database (upper layer topology DB) 210, an upper layer packet handling operation database (upper layer packet handling operation DB) 211, a lower layer packet handling operation database (lower layer packet handling operation DB) 212, and a node communication unit 213 communicating with the edge nodes 10 and the transport nodes 40.

The upper layer management unit 201 manages upper layer link information and packet forwarding information. More specifically, the upper layer management unit 201 manages the links among the edge nodes 10-1 to 10-4 included in the control target network, as the upper layer link information. For example, the network in FIG. 3 includes four edge nodes, and the links L01 to L06 connect these edge nodes to each other. Information defining a relationship between the set of links (L01 to L06) and the set of the edge nodes 10-1 to 10-4 corresponding to the links is the upper layer link information.

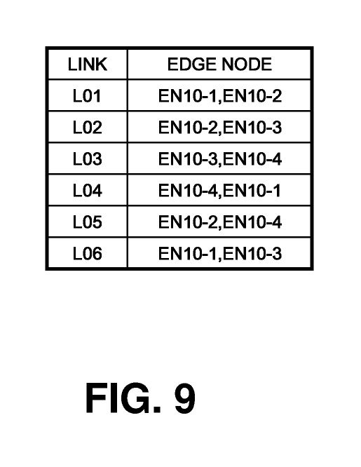

FIG. 9 illustrates the upper layer link information. By referring to FIG. 9, the edge nodes 10 corresponding to the six links formed among the edge nodes 10-1 to 10-4 can be understood.

The network administrator uses the communication terminal 30 to input the upper layer link information to the control apparatus 20. The upper layer management unit 201 registers the upper layer link information, which has been inputted via the node communication unit 213 communicating with the communication terminal 30, in the upper layer management DB 207.

In addition, the upper layer management unit 201 manages information about the paths among the edge nodes 10-1 to 10-4 included in the network, as the packet forwarding information. For example, the packet forwarding information corresponds to a routing table in a network layer (a third layer).

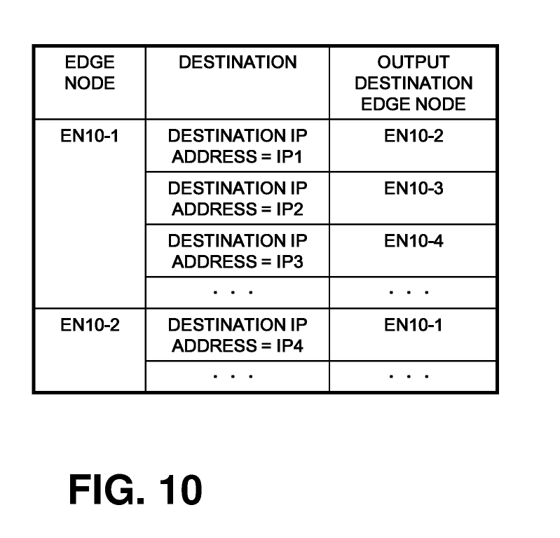

FIG. 10 illustrates the packet forwarding information. If the packet forwarding information as illustrated in FIG. 10 is used, when any one of the edge nodes 10-1 to 10-4 receives an incoming packet, an edge node to which the incoming packet needs to be forwarded can be determined based on the destination IP address of the incoming packet. The network administrator determines the packet forwarding information and inputs the packet forwarding information to the control apparatus 20 by using the communication terminal 30. The upper layer management unit 201 registers the packet forwarding information in the upper layer management DB 207.

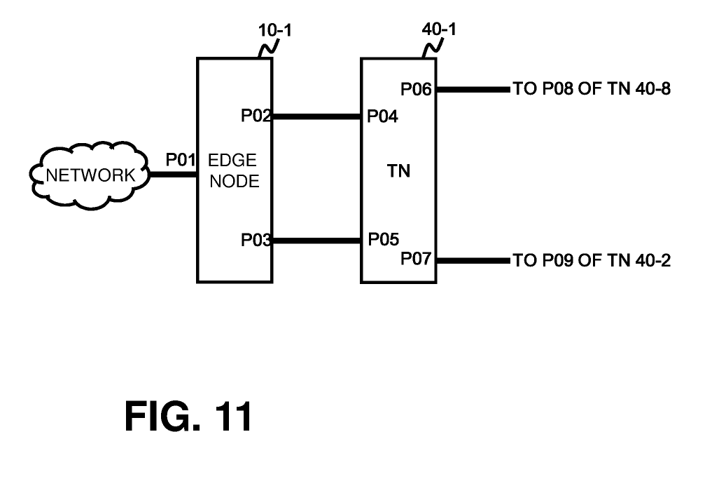

The lower layer management unit 202 manages the physical layer configuration information. FIG. 11 illustrates connection of ports of the edge node 10-1 and the transport node 40-1. In FIG. 11, the edge node 10-1 has a port P01 connected to an external network, a port P02 to a port P04 of the transport node 40-1, and a port P03 to a port P05 of the transport node 40-1. In addition, the transport node 40-1 has a port P06 connected to a port P08 of the transport node 40-8 and a port P07 to a port P09 of the transport node 40-2.

As illustrated in FIG. 11, the lower layer management unit 202 manages information about physical connections among the nodes (the edge nodes 10 and the transport nodes 40) as the physical layer configuration information. The network administrator uses the communication terminal 30 to input the physical layer configuration information to the control apparatus 20. The lower layer management unit 202 registers the physical layer configuration information in the lower layer management DB 208.

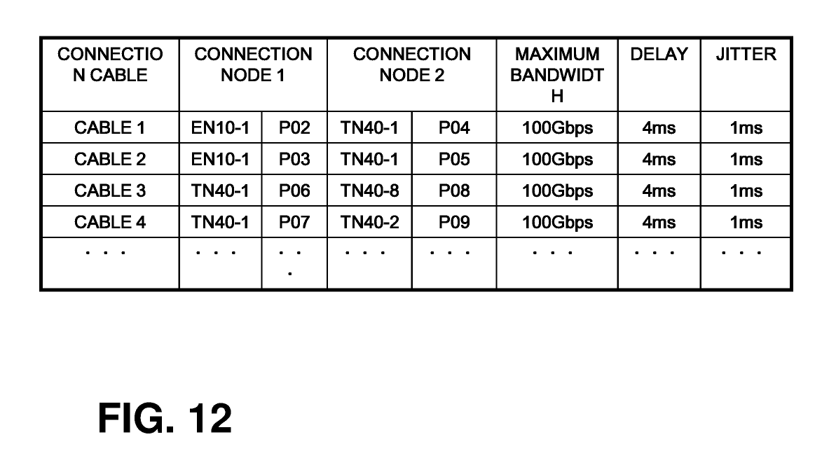

FIG. 12 illustrates the physical layer configuration information. While FIG. 12 and subsequent drawings thereof include bandwidth values, delay values, jitter values, etc., these values are used as examples to facilitate understanding of the present disclosure. Thus, the values according to the present disclosure are not limited to these values in the drawings.

As illustrated in FIG. 12, the physical layer configuration information includes information per node connection cable (an Ethernet (registered mark) cable or an optical fiber cable), the information being about connection nodes, connection ports, a maximum bandwidth, a delay amount, a jitter, etc. when the corresponding cable is used. For example, it is seen that the maximum bandwidth value of a cable connecting the ports P02 and P04 illustrated in FIG. 11 is 100 Gbps, the delay amount is 4 ms, and the jitter is 1 ms. For ease of understanding, the following description will be made assuming that the maximum bandwidth value, the delay, and the jitter of a single optical fiber cable are 100 Gbps, 4 ms, and 1 ms, respectively. In addition, the optical path bandwidth set in a single optical fiber cable is 10 Gbps. However, needless to say, characteristics of an optical fiber cable are not limited to the above values.

The operation management unit 203 analyzes an operation (inputted information) performed by the network administrator on the control apparatus 20. If, as a result of the analysis, the operation management unit 203 determines that the network administrator has inputted a new operation policy, the operation management unit 203 registers the operation policy in the operation policy DB 209.

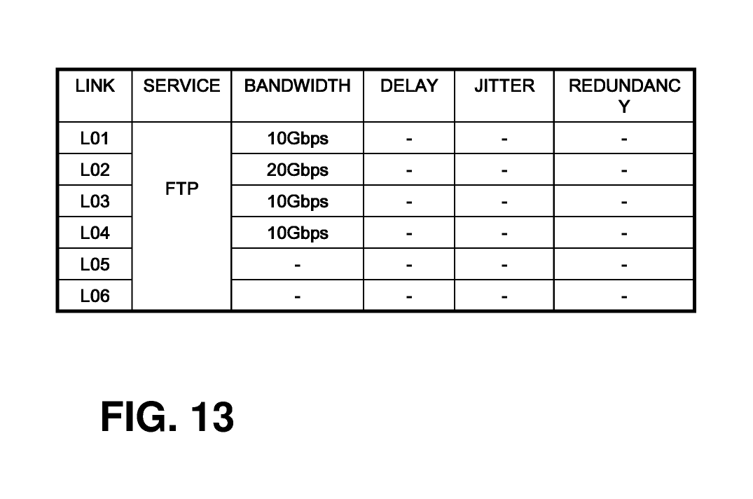

FIG. 13 illustrates an operation policy inputted by a network administrator. Referring to FIG. 13, it is seen that the network administrator can input a requirement relating to the bandwidth, delay, jitter, and redundancy about an upper layer link, per service provided by the network. In FIG. 13, a blank (“-”) in each section signifies that no requirement from the network administrator exists. For example, while a blank “-” appears as the bandwidths of the links L05 and L06, this signifies that these links may or may not be formed. Likewise, the operation policy in FIG. 13 signifies that no requirement relating to the delay, jitter, and path redundancy exists for the links. If a link includes a requirement relating to the path redundancy, physically different route of optical path (or packet paths) need to be used for realizing the link (different physical cables and apparatuses on which paths are set need to be used). Namely, forming a plurality of optical paths on a physical route is not deemed to be path redundancy.

If a packet received by the network controlled by the control apparatus 20 is a packet relating to a File Transfer Protocol (FTP) service, the operation policy illustrated in FIG. 13 requires a bandwidth of 20 Gbps or more in the link L02 and a bandwidth of 10 Gbps in the links L01, L03, and L04.

After registering the operation policy in the operation policy DB 209, the operation management unit 203 instructs the upper layer topology generation unit 204 to perform link calculation. In addition, when receiving an input of a lower layer topology previously determined by the network administrator, the operation management unit 203 transmits a notification and the inputted lower layer topology to the lower layer management unit 202. When receiving the notification, the lower layer management unit 202 registers the lower layer topology in the lower layer management DB 208.

Based on lower layer paths and the operation policy, the upper layer topology generation unit 204 generates an upper layer topology that can satisfy the requirements (the operation policy) for the upper layer links. The upper layer topology generation unit 204 registers the generated upper layer topology in the upper layer topology DB 210. As described below, the upper layer topology generation unit 204 also refers to the physical layer configuration information stored in the lower layer management DB 208, as needed. Details of the link calculation by the upper layer topology generation unit 204 will be described below.

The upper layer packet handling operation generation unit 205 generates packet handling operations that are set in the edge nodes 10, based on the upper layer link information, the packet forwarding information, and the physical layer configuration information. The upper layer packet handling operation generation unit 205 generates packet handling operations defining operations of the edge nodes 10-1 to 10-4 necessary for realizing the upper layer topology generated by link calculation. The upper layer packet handling operation generation unit 205 registers the generated packet handling operations in the upper layer packet handling operation DB 211 and sets the packet handling operations in the edge nodes 10-1 to 10-4 via the node communication unit 213.

The lower layer packet handling operation generation unit 206 generates packet handling operations that are set in the transport nodes 40, based on the upper layer link information, the packet forwarding information, and the physical layer configuration information. The lower layer packet handling operation generation unit 206 generates packet handling operations defining operations of the transport nodes 40-1 to 40-9 necessary for realizing the upper layer topology generated by link calculation. The lower layer packet handling operation generation unit 206 registers the generated packet handling operation in the lower layer packet handling operation DB 212 and sets the packet handling operations in the transport nodes 40-1 to 40-9 via the node communication unit 213.

The upper layer packet handling operation generation unit 205 and the lower layer packet handling operation generation unit 206 may set packet handling operations in the nodes (edge nodes 10 and transport nodes 40) when the network administrator actually applies an operation policy previously inputted to the control apparatus 20 to the network. For future network operations, the network administrator inputs operation policy (policies) of each service to the control apparatus 20. The control apparatus 20 generates an upper layer topology based on such inputted operation policy. When a service defined by the operation policy is actually started, the network administrator gives an instruction about starting the service to the control apparatus 20. Upon receiving the instruction, based on the upper layer topology generated by the operation policy, the control apparatus 20 determines a route of an upper layer for the service and generates and sets a packet handling operation in each node.

Alternatively, when performing link calculation, the upper layer topology generation unit 204 may notify the upper and lower layer packet handling operation generation units 205 and 206 that an upper layer topology has been generated. In addition, in this case, when notified, the upper and lower layer packet handling operation generation units 205 and 206 generate packet handling operations to be set.

Each unit (processing means) of the control apparatus 20 in FIG. 8 can be realized by a computer program causing a computer constituting the control apparatus 20 to use its hardware and to execute each processing described below.

Next, an operation of the control apparatus 20 will be described.

Prior to description of an operation of the control apparatus 20, a lower layer topology previously determined when the network administrator operates a network will be described.

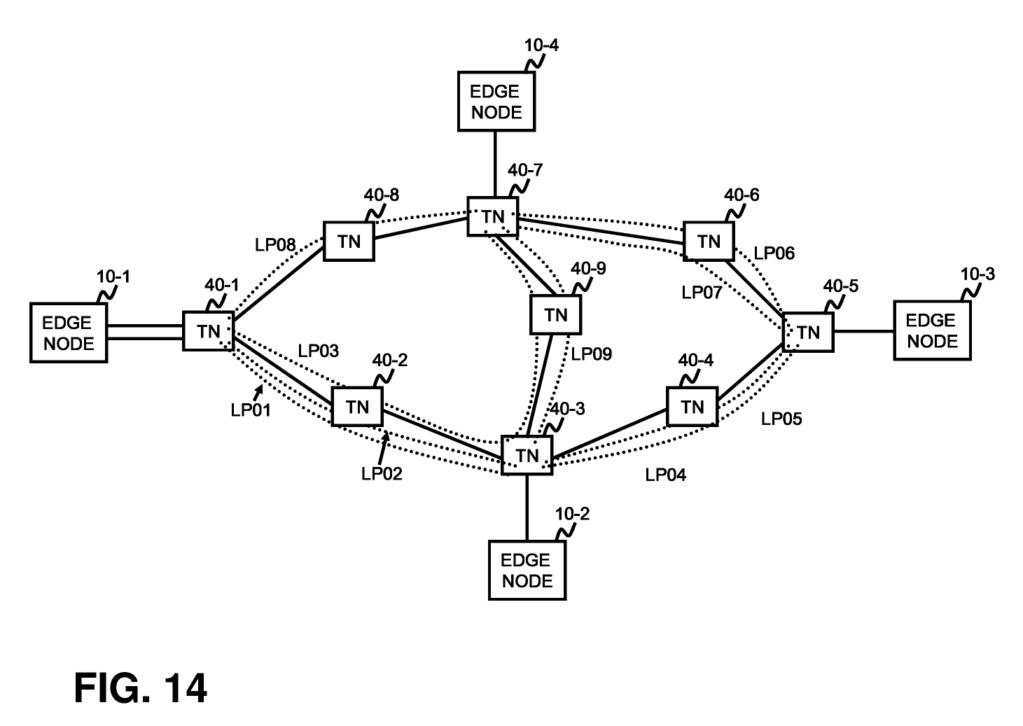

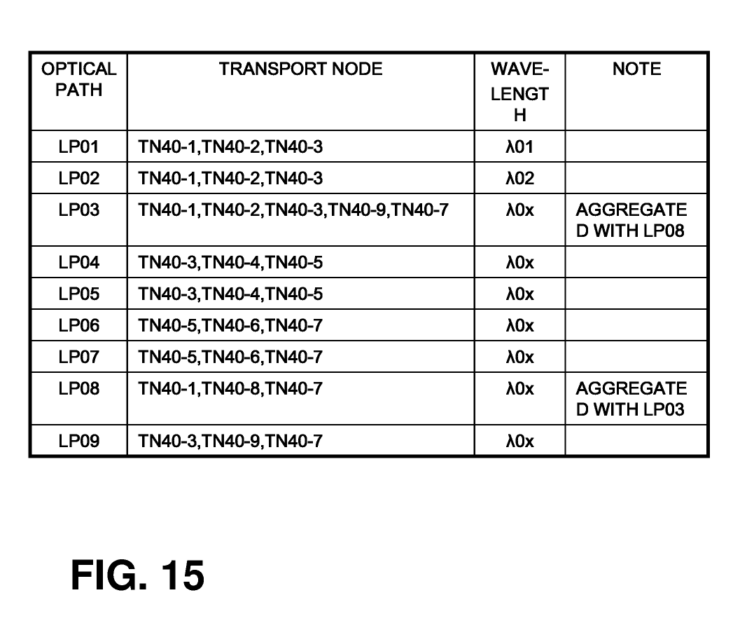

FIG. 14 illustrates a lower layer topology previously determined by a network administrator. The network administrator determines the lower layer paths as illustrated in FIG. 14 before operating the network illustrated in FIG. 3. The lower layer paths illustrated in FIG. 14 are formed by nine optical paths LP01 to LP09. FIG. 15 is a table representing details of the nine optical paths illustrated in FIG. 14. In FIGS. 14 and 15, the optical path LP01 goes through the transport nodes 40-1, 40-2, and 40-3. In addition, a wavelength of lambda01 is set in the optical path LP01. While the optical paths LP01 and LP02 are the same route, different wavelengths are set in the optical paths LP01 and LP02. Thus, the edge nodes 10-1 and 10-2 treat these optical paths as different paths. In addition, since both the optical paths LP03 and LP08 use the transport nodes 40-1 and 40-7 as the ends of the paths, the optical paths are aggregated (link aggregation) when used. Thus, the edge nodes 10-1 and 10-4 treat these optical paths as a single path in the upper layer. In FIG. 15 and the subsequent drawings thereof, unless the wavelengths set in the optical paths need to be distinguished, these wavelengths will be described as lambda0x.

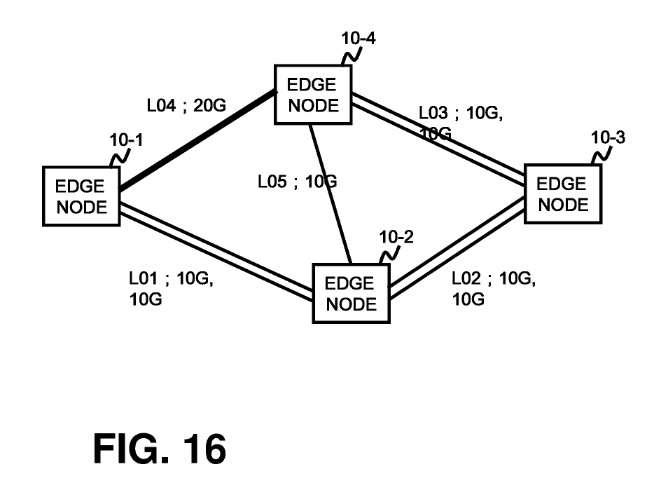

By referring to FIGS. 14 and 15, the upper layer topology can be represented as illustrated in FIG. 16. In FIG. 16, two paths having a bandwidth of 10 Gbps are set between the edge nodes 10-1 and 10-2. In contrast, a single link having a bandwidth of 20 Gbps is formed between the edge nodes 10-1 and 10-4. Since the optical paths LP03 and LP08 are aggregated, the link between the edge nodes 10-1 and 10-4 has a bandwidth of 20 Gbps. Each link is denoted by reference characters, and a number next to such reference characters is a characteristic value of the corresponding link (bandwidth in FIG. 16).

Next, an operation in which the network administrator inputs a new operation policy to the control apparatus 20 via the communication terminal 30 and the control apparatus 20 generates an upper layer topology will be described. This operation will be described assuming that the network administrator inputs the operation policy in FIG. 13.

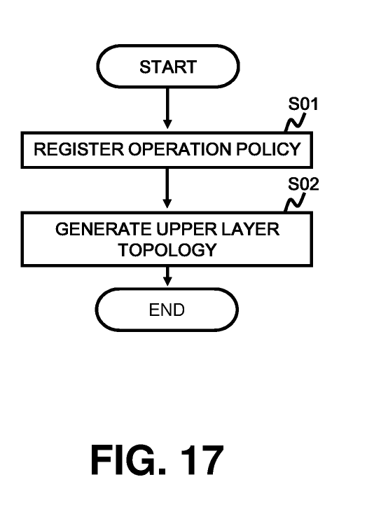

FIG. 17 is a flowchart illustrating an operation of the control apparatus 20.

In step S01, the operation management unit 203 registers the operation policy inputted by the network administrator in the operation policy DB 209. In addition, the operation management unit 203 instructs the upper layer topology generation unit 204 to perform link calculation for the new operation policy.

In step S02, the upper layer topology generation unit 204 performs link calculation for the new operation policy.

After step S02, an upper layer topology corresponding to the inputted operation policy is generated. Next, the upper layer packet handling operation generation unit 205 and the lower layer packet handling operation generation unit 206 generate necessary packet handling operations and set the generated packet handling operations in necessary edge nodes 10 and transport nodes 40.

Next, the link calculation performed by the upper layer topology generation unit 204 will be described.

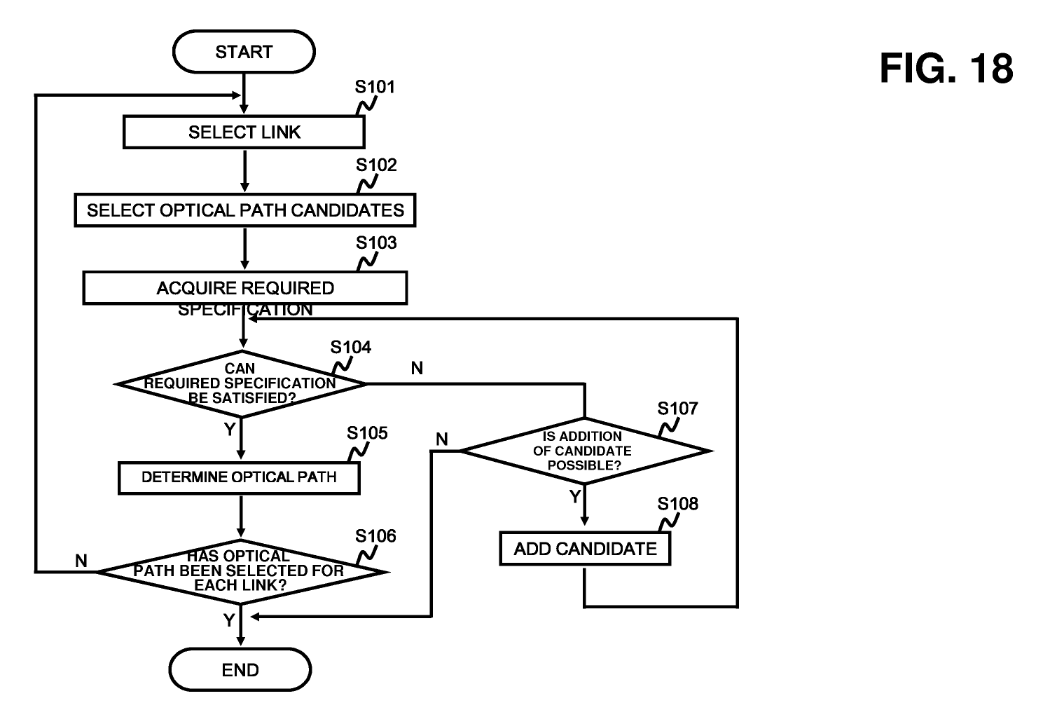

FIG. 18 is a flowchart illustrating the link calculation performed by the upper layer topology generation unit 204. The processing illustrated in FIG. 18 is principally performed by the upper layer topology generation unit 204.

In step S101, a single link is selected from the links forming the upper layer. For example, the link L01 is selected from the six links illustrated in FIG. 3.

In step S102, optical path candidates realizing the selected link are selected from the lower layer paths. For example, the optical paths LP01 and LP02 are selected for the link L01 (see FIGS. 14 and 15).

In step S103, a requirement(s) relating to the link selected in step S101 is acquired from the operation policy. Referring to the operation policy illustrated in FIG. 13, a bandwidth of 10 Gbps or more is required for the link L01.

In step S104, whether the optical path candidates selected in step S102 can form the link is determined, satisfying the requirement recognized in the previous step. For example, the optical path candidates realizing the link L01 are the optical paths LP01 and LP02. Since the bandwidth of either optical path is 10 Gbps, either optical path can be used. Thus, it is determined that either optical path can form the link L01 (True (Yes) in step S104).

In step S105, an optical path for the link selected in step S101 is determined. For example, since either the optical path LP01 or LP02 satisfies the specification required by the operation policy of the link L01, either the optical path LP01 or LP02 is selected. In this example, the optical path LP01 is selected.

In step S106, whether an optical path has been selected for each of the links is determined. In this example, since only the optical path for the link L01 has been determined, the processing returns to step S101 (No in step S106).

After the link L02 is selected, in step S102, the optical paths LP04 and LP05 are selected as candidates. Next, the specification required for the link L02 is determined by referring to the corresponding operation policy. It is seen that a bandwidth of 20 Gbps or more is required (the second top operation policy in FIG. 13). The lower layer topology previously determined by the network administrator defines that the optical paths LP04 and LP05 need to be used separately. Thus, the specification (a bandwidth of 20 Gbps or more) required by the corresponding operation policy cannot be satisfied by only one of the optical paths (No in step S104).

In this case, in step S107, whether addition of an optical path candidate is possible is determined. Since the requirement for the link L02 is a bandwidth, whether aggregation of optical paths is possible is determined in this step. If addition of an optical path candidate (aggregation of optical paths) is possible, optical paths are aggregated in step S108. Next, the determination in step S104 is made on the aggregated optical path (which will hereinafter be referred to as an optical path LP45). Since the optical path LP45 is an aggregation of the two optical paths, the bandwidth of the optical path LP45 is 20 Gbps. Thus, the optical path LP45 satisfies the requirement of the operation policy. In step S105, the optical path LP45 is determined to be the optical path for the link L02.

Similarly, after the links L03 to L06 are processed and an optical path is selected for each of the links, the control apparatus 20 ends the processing in FIG. 18.

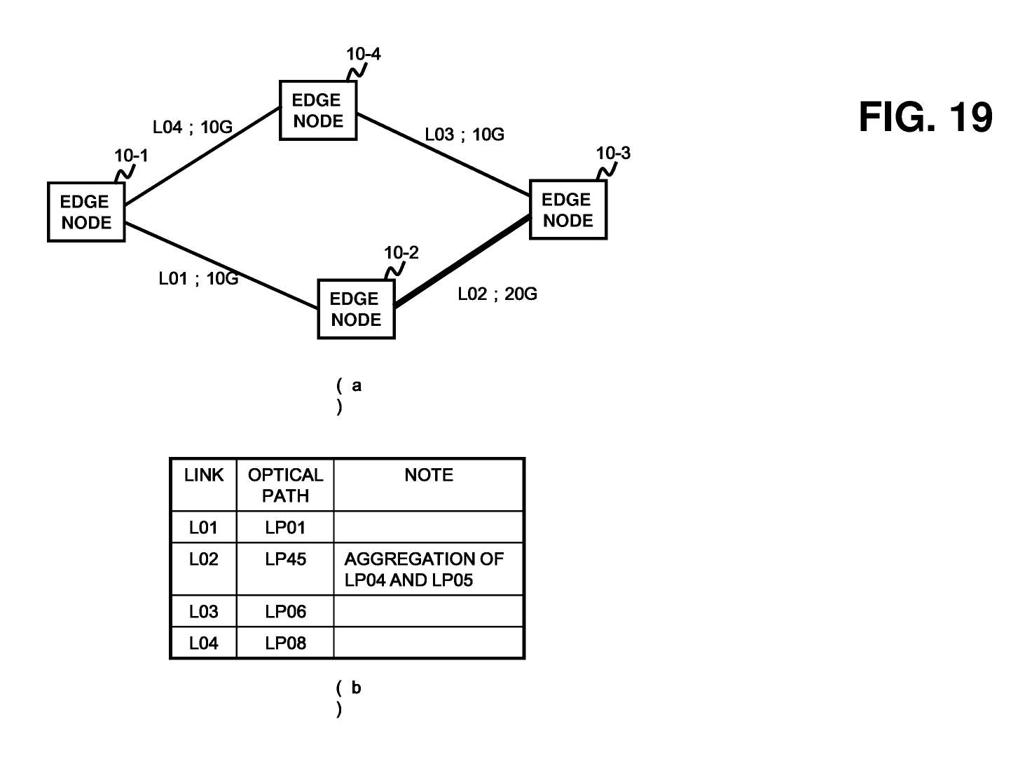

FIG. 19 illustrates an upper layer topology generated after the link calculation is completed. When the upper layer topology in FIG. 16 and the upper layer topology in FIG. 19 are compared, the number of the paths forming the links L01, L03, and L04 is changed from 2 to 1. In addition, the link L02 is realized by aggregating two optical paths. In addition, the link L05 is deleted. By executing link calculation, the upper layer topology generation unit 204 generates an upper layer topology sufficient for satisfying the specifications required in the operation policy defined by a network administrator. The upper layer topology generation unit 204 registers the generated upper layer topology in the upper layer topology DB 210.

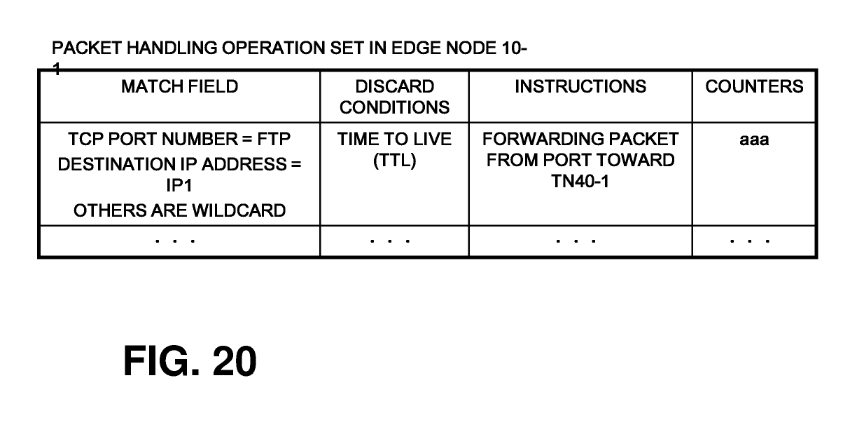

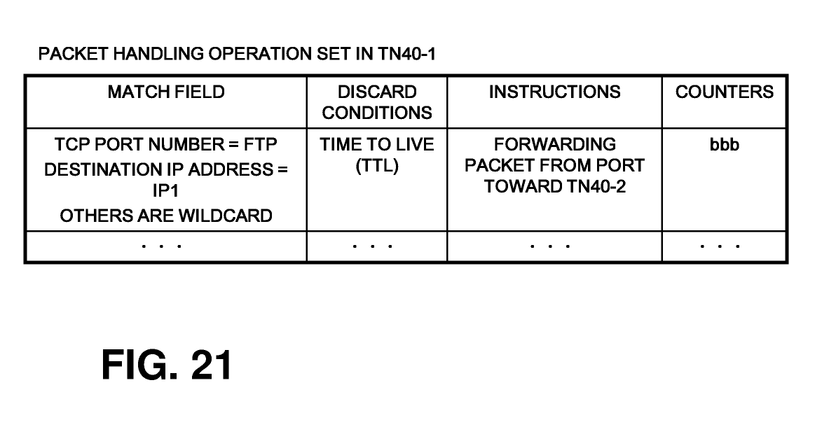

When a service is started, the upper layer packet handling operation generation unit 205 and the lower layer packet handling operation generation unit 206 generate packet handling operations to be set in the edge nodes 10 and transport nodes 40, based on the upper layer topology generated by link calculation. For example, the upper layer packet handling operation generation unit 205 generates a packet handling operation illustrated in FIG. 20 as a packet handling operation (processing rule) to be set in the edge node 10-1. The packet handling operation illustrated in FIG. 20 indicates that packets which relate to an FTP service and whose destination IP address is IP1 need to be forwarded from a port toward the transport node 40-1. In addition, the lower layer packet handling operation generation unit 206 generates a packet handling operation illustrated in FIG. 21 as a packet handling operation (processing rule) to be set in the transport node 40-1. The packet handling operation illustrated in FIG. 21 indicates that packets which relate to an FTP service and whose destination IP address is IP1 need to be forwarded from a port toward the transport node 40-2.

The present exemplary embodiment has been described based on an example where the upper layer topology generation unit 204 generates an upper layer topology when the network administrator inputs an operation policy to the control apparatus 20. However, the upper layer topology generation unit 204 may perform link calculation and generate an upper layer topology when a node (an edge node 10 or a transport node 40) transmits a query when the node receives a packet that relates to a service (port number) or a forwarding destination (destination IP address) that is not described in the corresponding packet handling operation.

In addition, the present exemplary embodiment has been described assuming that the network administrator sets the packet forwarding information that is stored in the control apparatus 20. However, if each node (each edge node 10 and each transport node 40) supports a routing protocol such as BGP and autonomously creates a routing table, the control apparatus 20 may collect advertisements relating to route switching and create and manage routing tables set in each node.

In addition, the present exemplary embodiment has been described assuming that the transport nodes 40 are optical cross-connects. Namely, in the present exemplary embodiment, a path forming a link between edge nodes is an optical path. However, the transport nodes 40 may be apparatuses forming packet paths, such as packet transport nodes.

In addition, the present exemplary embodiment has been described assuming that the control target apparatuses of the control apparatus 20 are the edge nodes 10 and the transport nodes 40. However, depending on the network configuration, the control target apparatuses of the control apparatus 20 are limited to either the edge nodes 10 or the transport nodes 40. In addition, in the present exemplary embodiment, the control target apparatuses of the control apparatus 20 are a plurality of apparatuses (the edge nodes 10 and the transport nodes 40) belonging to the upper layer and the lower layer. However, depending on the network configuration, the control apparatus 20 does not control a plurality of control target apparatuses.

As described above, link calculation performed by the control apparatus 20 according to the present exemplary embodiment generates an upper layer topology that can satisfy the specifications required by operation policy, from previously-determined lower layer paths. In other words, an upper layer topology is generated by selecting the paths appropriate for the operation policy from the lower layer paths forming the upper layer links. Thus, it is possible to generate an upper layer topology that guarantees a service defined by the operation policy and the content of the service (bandwidth, etc. required for the links). Namely, an appropriate upper layer topology is determined for each series of packets relating to a certain service. In addition, resources of a network are not used more than the service content defined by the operation policy requires, and the resources of the network to be used are not changed. As a result, the network can be operated appropriately, efficiently, and stably.

### Second Exemplary Embodiment

Next, a second exemplary embodiment will be described in detail with reference to the drawings.

In the present exemplary embodiment, link calculation based on an operation policy different from those according to the first exemplary embodiment will be described. Since the internal configurations and the like of the control apparatus 20, the edge nodes 10, and the transport nodes 40 according to the present exemplary embodiment are not different from those according to the first exemplary embodiment, further description of these elements will be omitted.

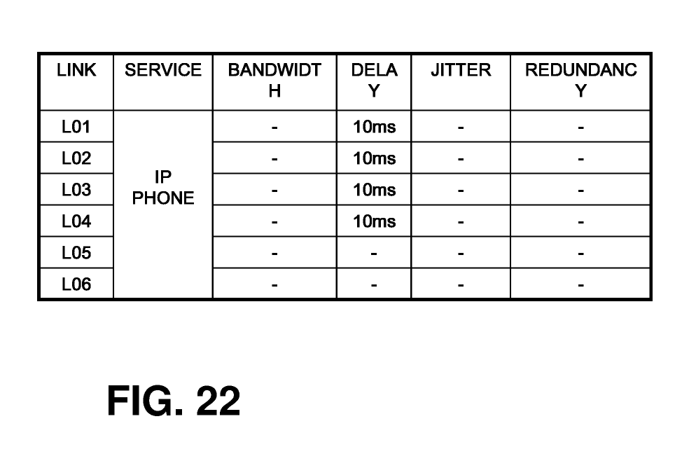

FIG. 22 illustrates an operation policy. The operation policy illustrated in FIG. 22 is different from those illustrated in FIG. 13 in that the service set by the network administrator is an IP (Internet Protocol) phone service and a requirement relating to each link is a requirement relating to a delay.

Link calculation performed when the operation policy illustrated in FIG. 22 is inputted by the network administrator will be described. When the operation policy illustrated in FIG. 22 is inputted by the network administrator, the upper layer topology generation unit 204 performs processing similar to the link calculation described in the first exemplary embodiment for each link. In this processing, since the requirement for each link is not about a bandwidth but about a delay, a delay of a link formed by an optical path candidate is compared with a delay required by each operation policy to select optical paths satisfying the requirements.

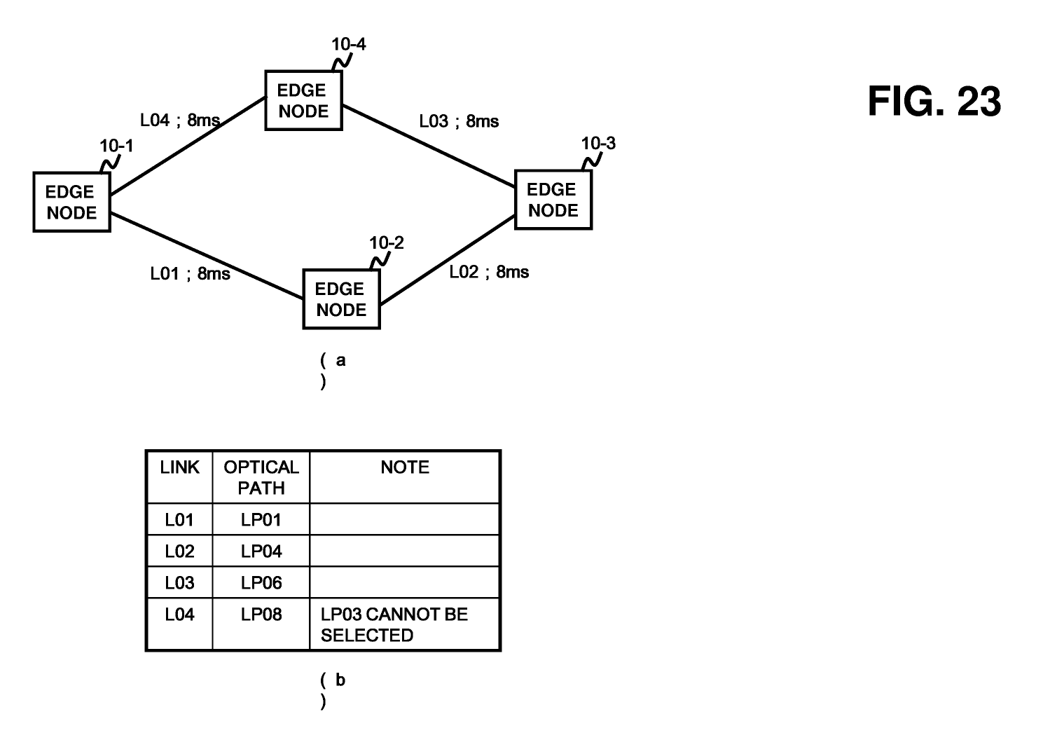

FIG. 23 illustrates a generated upper layer topology after the link calculation. In the upper layer topology illustrated in FIG. 23, each of the links L01 to L04 is formed by a single optical path. While two optical paths are selected as candidates for each of the links L01 to L03, either optical path satisfies the delay amount required by the corresponding operation policy. As described above, this is because, if each of the optical fiber cables is set to have a delay amount of 4 ms, since the optical paths as the candidates of the links L01 to L03 use two optical fiber cables, the total delay amount of each cable is 8 ms. For the link L04, two optical paths are also used as candidates (the optical paths LP03 and LP08). However, the optical path LP03 cannot be determined as an optical path realizing the link L04. Since the optical path LP03 uses four optical fiber cables, the total delay amount thereof is 16 ms. Thus, the optical path LP03 does not satisfy the specification required. Therefore, the optical path LP08 is determined as the optical path realizing the link L04.

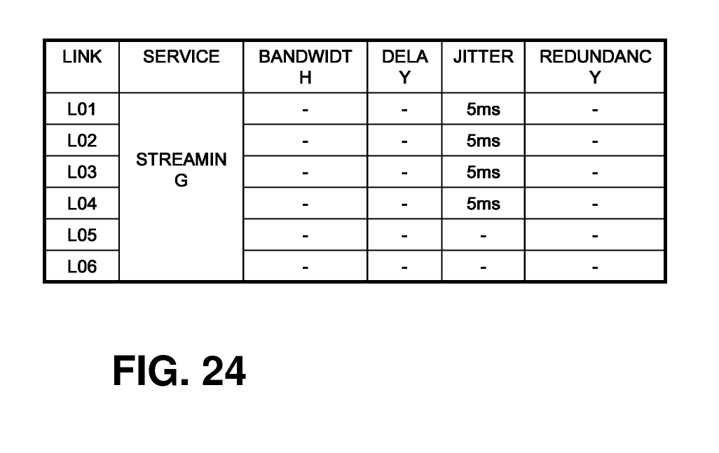

In addition, for example, when the network provides a video streaming service, an operation policy as illustrated in FIG. 24 is inputted. Even when requirements relating to a jitter are inputted, the upper layer topology generation unit 204 generates an upper layer topology as in the case of the above the operation policy relating to a delay.

As described above, even when the operation policy includes requirements relating to a delay, a jitter, or the like, it is possible to generate an upper layer topology satisfying the specifications required in the communication system.

### Third Exemplary Embodiment

Next, a third exemplary embodiment will be described in detail with reference to the drawings.

In the present exemplary embodiment, link calculation performed when the operation policy different from those according to the first exemplary embodiment is inputted will be described. Since the internal configurations and the like of the control apparatus 20, the edge nodes 10, and the transport nodes 40 according to the present exemplary embodiment are not different from those according to the first exemplary embodiment, further description of these elements will be omitted.

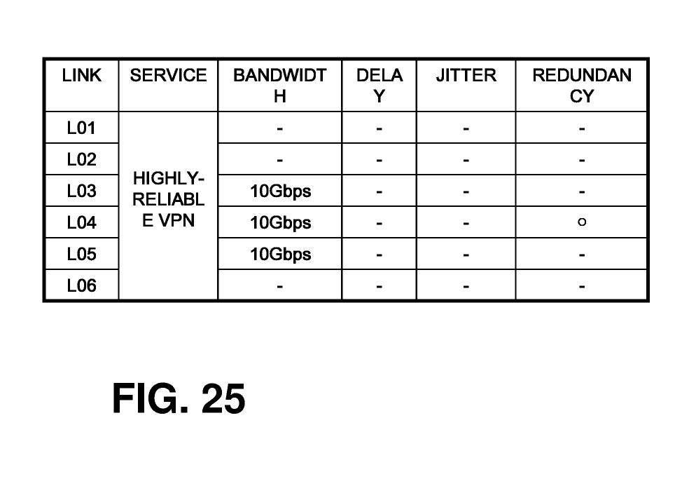

FIG. 25 illustrates an operation policy. The operation policy illustrated in FIG. 25 is different from those illustrated in FIG. 13 in that the service set by the network administrator is a highly-reliable VPN (Virtual Private Network) service and redundancy is required for the link L04. In order to ensure the minimum connectivity (Reachability) in the network, 10 Gbps is set as a bandwidth required for the links L03 to L05.

Link calculation performed when the operation policy illustrated in FIG. 25 is inputted by the network administrator will be described. When the operation policy illustrated in FIG. 25 is inputted by the network administrator, optical paths are determined for the links L03 and L05 by the same method as that described in the first exemplary embodiment. More specifically, the optical paths LP06 and LP09 are selected for the links L03 and L05, respectively. The optical paths LP06 and LP09 are determined to be the optical paths realizing the respective links.

However, since path redundancy is required for the link L04, the processing proceeds to step S107 in FIG. 18. Since the specification required for the link L04 is path redundancy, a single optical path (the optical path LP03 or LP08) cannot satisfy the requirement. Thus, inevitably, the processing proceeds to step S107.

In this case, in step S107, the upper layer topology generation unit 204 determines whether a plurality of optical paths realizing the link selected in step S101 exist and whether the optical paths use different physical routes. If such plurality of optical paths exist, the upper layer topology generation unit 204 determines that the requirement relating to path redundancy can be satisfied. For example, for the link L04, since the optical paths LP03 and LP08 use different physical routes (going through transport nodes 40), the optical paths LP03 and LP08 are determined to satisfy the redundancy for the link L04.

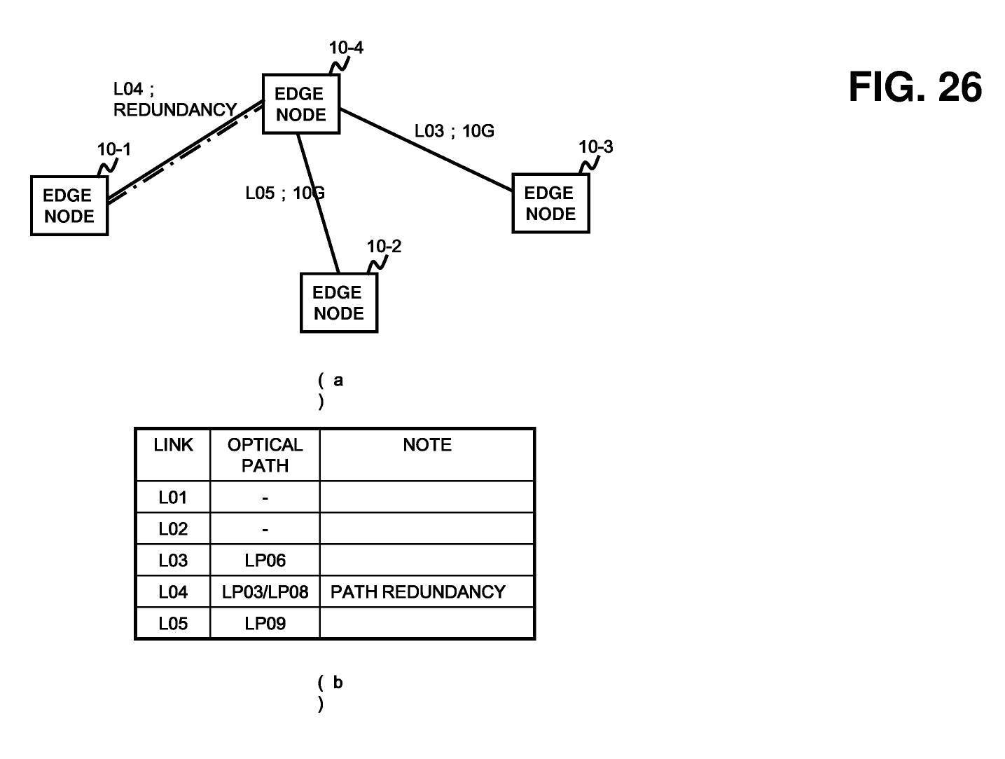

FIG. 26 illustrates a generated upper layer topology after the link calculation. In the upper layer topology illustrated in FIG. 26, each of the links L03 and L05 is formed by a single optical path. In contrast, both of the optical paths LP03 and LP08 are used for the link L04. Thus, path redundancy forming the link L04 can be realized.

As described above, even when an operation policy requires path redundancy, it is possible to generate an upper layer topology satisfying the requirement.

### Fourth Exemplary Embodiment

Next, a fourth exemplary embodiment will be described in detail with reference to the drawings.

In the present exemplary embodiment, the upper layer topology generation unit 204 can perform link calculation even when an operation policy inputted by the network administrator includes a plurality of requirements for a link. Since the internal configurations and the like of the control apparatus 20, the edge nodes 10, and the transport nodes 40 according to the present exemplary embodiment are not different from those according to the first exemplary embodiment, further description of these elements will be omitted.

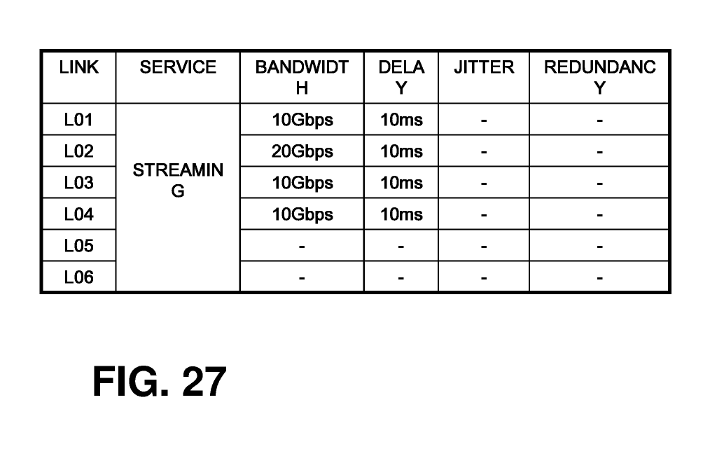

FIG. 27 illustrates an operation policy. In FIG. 27, it is seen that the network administrator requires a 20 Gbps or more as the bandwidth of the link L02 and 10 ms or less as the delay of the links L01 to L04.

In the case of this operation policy, the upper layer topology generation unit 204 separately calculates an upper layer topology satisfying the requirement relating to the bandwidths and an upper layer topology satisfying the requirement relating to the delay. Subsequently, by integrating the two upper layer topologies, the upper layer topology generation unit 204 generates an upper layer topology satisfying the operation policy.

As in the link calculation described in the first exemplary embodiment, the upper layer topology generation unit 204 performs link calculation to calculate an upper layer topology satisfying the requirement relating to the bandwidths. In addition, as in the link calculation described in the second exemplary embodiment, the upper layer topology generation unit 204 performs link calculation to calculate an upper layer topology satisfying the requirement relating to the delay.

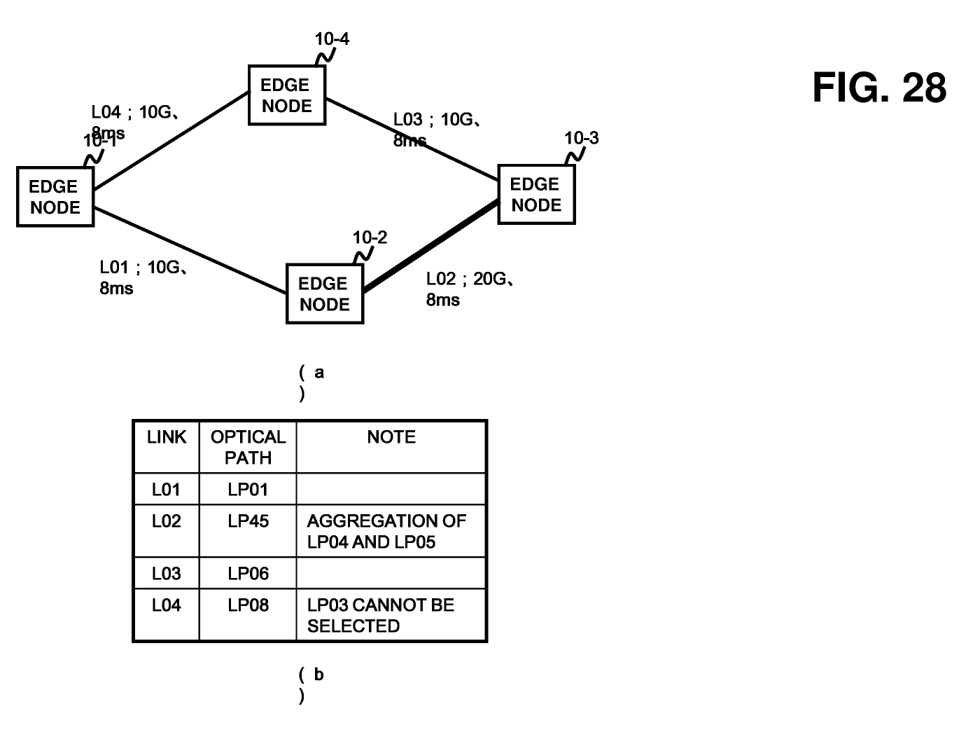

If the upper layer topology generation unit 204 performs link calculation for the requirement relating to the bandwidths, based on the specifications required by the operation policy in FIG. 27, the upper layer topology in FIG. 19 is obtained. In contrast, if the upper layer topology generation unit 204 performs link calculation for the requirement relating to the delay, based on the specification required by the operation policy in FIG. 27, an upper layer topology in FIG. 23 is obtained. Referring to FIGS. 19 and 23, it is seen that the links L01, L03, and L04 can be formed by the same optical paths. In addition, since the optical path LP45 is an optical path obtained by aggregating the optical paths LP04 and LP05, the optical path LP04 is included in the optical path LP45. An upper layer topology illustrated in FIG. 28 can be generated by integrating the upper layer topologies illustrated in FIGS. 19 and 23.

In the present exemplary embodiment, first, each of a plurality of upper layer topologies is calculated separately, and next, the calculated topologies are integrated. However, the following operation is also possible. The upper layer topology generation unit 204 may combine the link calculation for calculating an upper layer topology satisfying the requirement relating to the bandwidths and the link calculation for calculating an upper layer topology satisfying the requirement relating to the delay. For example, regarding the lower layer paths, the upper layer topology generation unit 204 first performs the link calculation relating to the bandwidths. Next, the upper layer topology generation unit 204 performs the link calculation relating to the delay. In this way, by sequentially performing a plurality of link calculations, the same upper layer topology as that obtained by the above operation can be obtained.

Thus, even when a plurality of requirements are included in an operation policy, it is possible to generate an upper layer topology satisfying the requirements.

### Fifth Exemplary Embodiment

Next, a fifth exemplary embodiment will be described in detail with reference to the drawings.

The fourth exemplary embodiment can achieve generation of an upper layer topology even when a plurality of requirements are included in an operation policy. However, when a plurality of operation policies are combined to generate a topology, a contradiction may be caused in generating such upper layer topology, depending on the content of an operation policy. In the present exemplary embodiment, a solution to such case will be described. Since the internal configurations and the like of the control apparatus 20, the edge nodes 10, and the transport nodes 40 according to the present exemplary embodiment are not different from those according to the first exemplary embodiment, further description of these elements will be omitted.

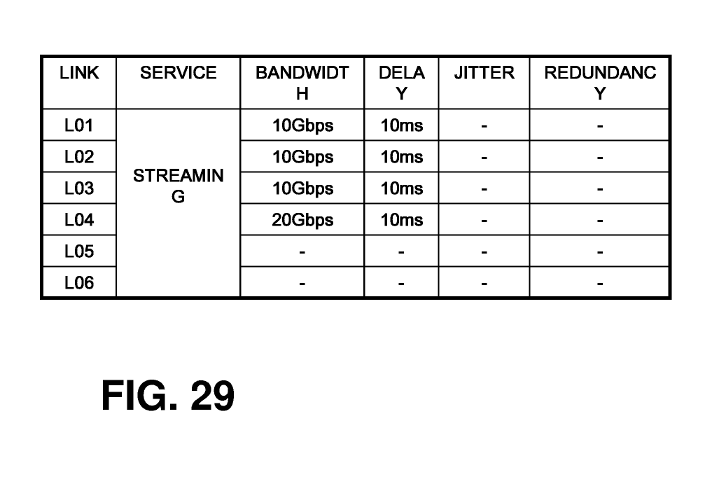

FIG. 29 illustrates an operation policy. The operation policy illustrated in FIG. 27 is different from those illustrated in FIG. 29 in that the link requiring a bandwidth of 20 Gbps is changed from the link L02 to link L04.

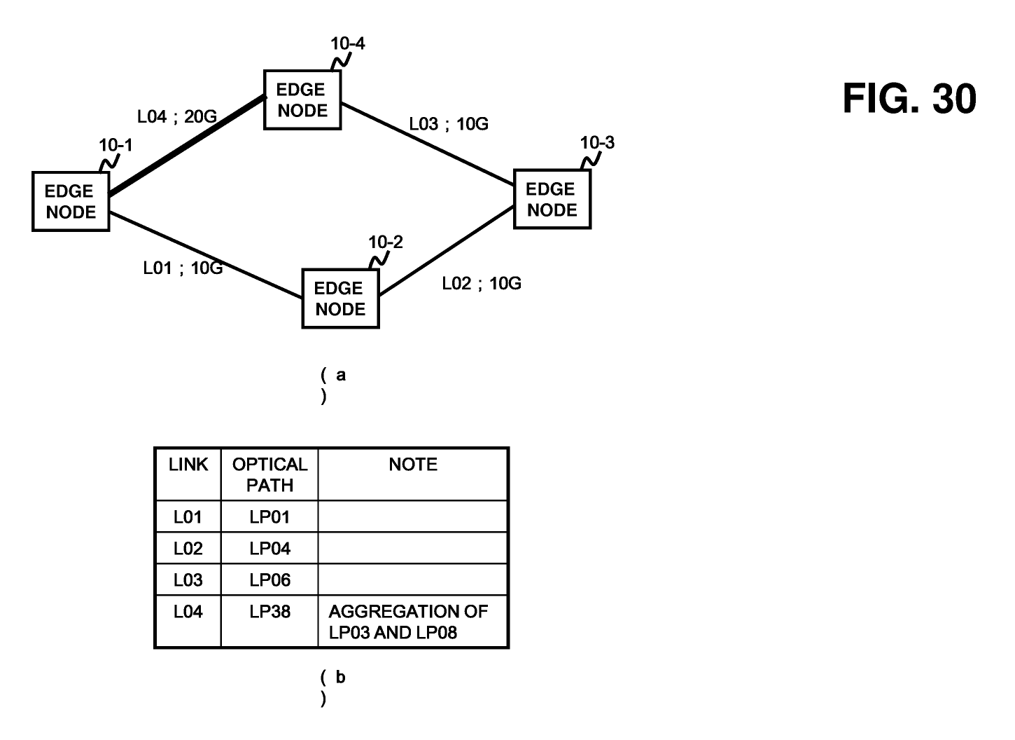

Link calculations are separately performed for the bandwidths and delay required by the operation policy illustrated in FIG. 29. When the link calculation relating to the bandwidths is performed, an upper layer topology illustrated in FIG. 30 is generated. When the link calculation relating to the delay is performed, the upper layer topology illustrated in FIG. 23 is generated.

If the upper layer topology generation unit 204 integrates these upper layer topologies, the link L04 cannot be realized. Namely, to satisfy the requirement that the relay is 10 ms or less, the optical path LP08 needs to be used for the link L04, as illustrated in FIG. 23. However, to ensure a bandwidth of 20 Gbps or more for the link L04, an optical path LP38 obtained by aggregating the optical paths LP03 and LP08 needs to be used.

Since these upper layer topologies contradict each other, an upper layer topology satisfying the requirements cannot be obtained. In other words, if the upper layer topologies obtained by separately performing the link calculations are integrated, without any modification, the operation policy for the link L04 cannot be satisfied. In such case, the upper layer topology generation unit 204 adds a new optical path to the lower layer topology and generates an upper layer topology satisfying the operation policy, without being restricted to the lower layer topology previously determined by a network administrator.

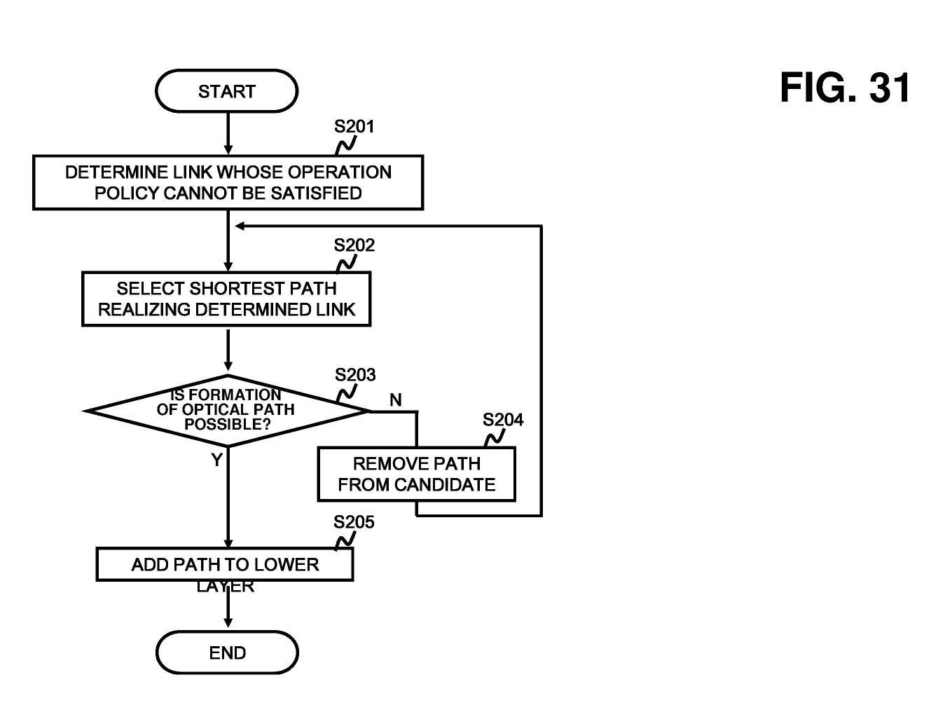

FIG. 31 is a flowchart illustrating an operation of the upper layer topology generation unit 204.

In step S201, the upper layer topology generation unit 204 determines a link whose operation policy cannot be satisfied. In the case of the operation policy in FIG. 29, the link L04 is determined to be the link whose operation policy cannot be satisfied.

In step S202, a shortest route (the number of transport nodes 40 to be used is the smallest) that can realize the determined link is selected. For example, for the link L04, the route using the transport nodes 40-1, 40-8, and 40-7 is the shortest. Thus, the route using the transport nodes 40-1, 40-8, and 40-7 is selected as the shortest route.

In step S203, whether an optical path can be formed on the shortest route selected in the previous step is determined. For the determination, the upper layer topology generation unit 204 uses the physical layer configuration information. For example, referring to the physical layer configuration information illustrated in FIG. 12, the maximum bandwidth of the optical fiber cable between the transport nodes 40-1 and 40-8 and the optical fiber cable between the transport nodes 40-8 and 40-7 is 100 Gbps. However, referring to the lower layer topology illustrated in FIG. 15, only the single optical path LP08 (10 Gbps) goes through the transport nodes 40-1, 40-8, and 40-7. Thus, by referring to the physical layer configuration information and the lower layer topology, it is seen that an optical path corresponding to 90 Gbps can be formed on the route that goes through the transport nodes 40-1, 40-8, and 40-7 (Yes in step S203).

If an optical path cannot be formed any more on the route that goes through the transport nodes 40-1, 40-8, and 40-7 (No in step S203), the route (for example, the transport nodes 40-1, 40-8, and 40-7) is removed in step S204. Next, in step S202, a shortest route candidate that realizes the link determined in step S101 is selected, again. For example, next to the route using the transport nodes 40-1, 40-8, and 40-7, a route using the smallest number of transport nodes to be used is the route using the transport nodes 40-1, 40-2, 40-3, 40-9, and 40-7. After the route is selected, whether an optical path can be added is determined in step S203, again.

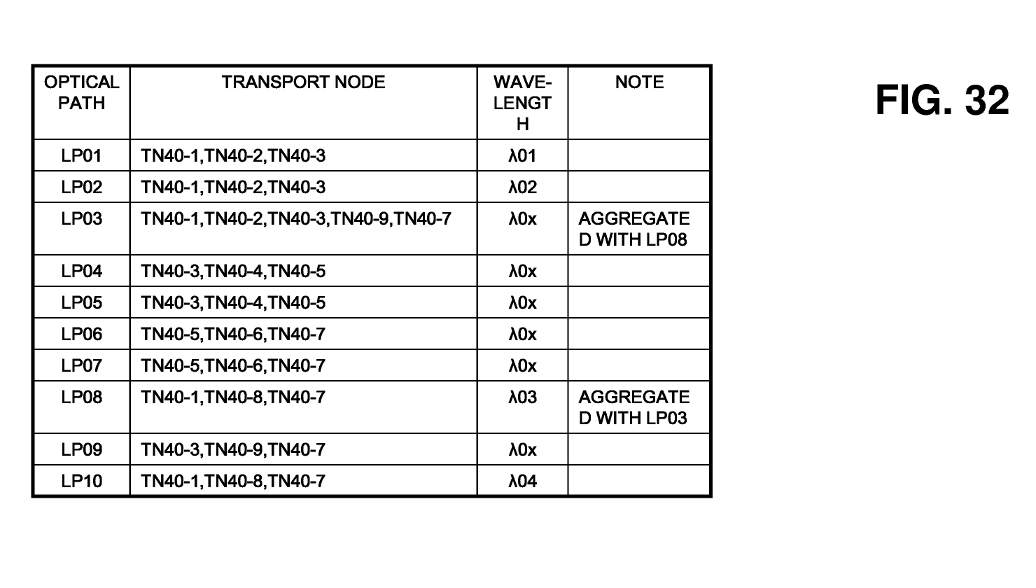

In step S205, the optical path, which has been determined to be true (Yes) in step S203, is added to the lower layer (registered in the lower layer management DB 208). FIG. 32 illustrates lower layer paths. After step S205, the lower layer paths as illustrated in FIG. 32 are registered in the lower layer management DB 208. In FIG. 32, a new optical path LP10 has been added. By using the updated lower layer paths, the upper layer topology generation unit 204 generates an upper layer topology satisfying the specifications required by the operation policy.

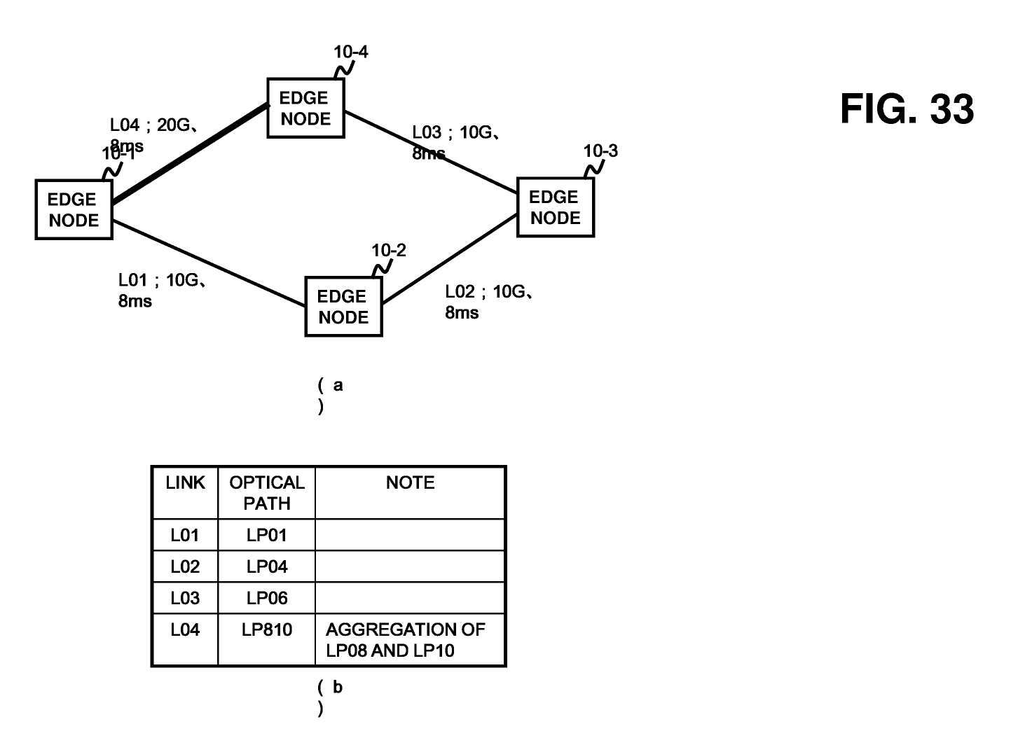

By performing link calculation based on the updated lower layer paths and the operation policy illustrated in FIG. 29, the upper layer topology generation unit 204 generates an upper layer topology illustrated in FIG. 33. Namely, the link L04 is realized by aggregating the optical paths LP08 and LP10. Since the number of optical fiber cables used by these optical paths is two, the total delay amount is 8 ms. Thus, the specification (a delay of 10 ms or less) required by the operation policy can be satisfied.

As described above, if a plurality of requirements are included in an operation policy and if the operation policy cannot be satisfied without modification, the lower layer paths are updated and link calculation is performed again. In this way, an upper layer topology satisfying the operation policy can be generated.

Part or all of the above exemplary embodiments can be described as the following modes. However, the present invention is not limited to the following modes.

### <Mode 1>

Mode 1 corresponds to the control apparatus according to the above first aspect.

### <Mode 2>

The control apparatus according to mode 1;
wherein the topology in the second layer is generated by selecting paths appropriate for the operation policy from the paths in the first layer forming links in the second layer.

### <Mode 3>

The control apparatus according to mode 2;
wherein operation policy includes a requirement for a link in the second layer; and
wherein the topology in the second layer is generated by selecting paths satisfying the requirement included in the operation policy from the paths in the first layer forming the links in the second layer to which the requirement is directed.

### <Mode 4>

The control apparatus according to mode 2 or 3;
wherein the topology in the second layer is generated by aggregating a plurality of paths in the first layer forming the links in the second layer.

### <Mode 5>

The control apparatus according to any one of modes 2 to 4;
wherein the topology in the second layer is generated by selecting paths whose routes are disjoint as the paths appropriate for the operation policy from the plurality of paths in the first layer forming the links in the second layer.

### <Mode 6>

The control apparatus according to any one of modes 2 to 5;
wherein, if the operation policy includes a plurality of requirements for a link in the second layer, topologies in the second layer generated for the plurality of requirements, respectively, are integrated to generate the topology in the second layer for the operation policy including the plurality of requirements.

### <Mode 7>

The control apparatus according to mode 6;
wherein the topology in the second layer is generated by adding a path forming a link in the second layer to a topology in the first layer, updating the topology in the first layer, and using the updated topology in the first layer.

### <Mode 8>

The control apparatus according to mode 7;
wherein, if paths appropriate for the operation policy including a plurality of requirements cannot be selected by using the integrated topology in the second layer, a path is added to the topology in the first layer.

### <Mode 9>

The control apparatus according to any one of modes 1 to 8;
wherein the operation policy includes a requirement for a link in the second layer used when the network provides a service; and
wherein, based on the topology in the second layer, packet handling operations for packets relating to the service are set in communication apparatus belonging to the first layer and/or the second layer.

### <Mode 10>

Mode 10 corresponds to the method of controlling a control apparatus according to the above second aspect.

### <Mode 11>

The method of controlling the control apparatus according to mode 10;
wherein, in the step of generating the topology in the second layer, the topology in the second layer is generated by selecting paths appropriate for the operation policy from the paths in the first layer forming links in the second layer.

### <Mode 12>

The control method of the control apparatus according to mode 11;
wherein the operation policy includes a requirement for a link in the second layer; and
wherein, in the step of generating the topology in the second layer, the topology in the second layer is generated by selecting paths satisfying the requirement included in the operation policy from the paths in the first layer forming the links in the second layer to which the requirement is directed.

### <Mode 13>

The control method of the control apparatus according to mode 11 or 12;
wherein, in the step of generating the topology in the second layer, the topology in the second layer is generated by aggregating a plurality of paths in the first layer forming the links in the second layer.

### <Mode 14>

The control method of the control apparatus according to any one of modes 11 to 13;
wherein, in the step of generating the topology in the second layer, the topology in the second layer is generated by selecting paths whose routes are disjoint as the paths appropriate for the operation policy from the plurality of paths in the first layer forming the links in the second layer.

### <Mode 15>

The control method of the control apparatus according to any one of modes 11 to 14;
wherein, in the step of generating the topology in the second layer, if the operation policy includes a plurality of requirements for a link in the second layer, topologies in the second layer generated for the plurality of requirements, respectively, are integrated to generate the topology in the second layer for the operation policy including the plurality of requirements.

### <Mode 16>

The control method of the control apparatus according to mode 15, further comprising steps of:
updating a topology in the first layer by adding a path forming a link in the second layer to the topology in the first layer; and
generating the topology in the second layer by using the updated first topology.

### <Mode 17>

The control method of the control apparatus according to mode 16;
wherein, in the step of updating the topology in the first layer, if paths appropriate for the operation policy including a plurality of requirements cannot be selected by using the integrated topology in the second layer, a path is added to the topology in the first layer.

### <Mode 18>

The control method of the control apparatus according to any one of modes 10 to 17;
wherein the operation policy includes a requirement for a link in the second layer used when the network provides a service; and
wherein, based on the topology in the second layer, packet handling operations for packets relating to the service are set in communication apparatus belonging to the first layer and/or the second layer.

### <Mode 19>

Mode 19 corresponds to the program according to the above third aspect.

### <Mode 20>

The program according to mode 19;
wherein, in the process of generating the topology in the second layer, the topology in the second layer is generated by selecting paths appropriate for the operation policy from the paths in the first layer forming links in the second layer.

### <Mode 21>

The program according to mode 20;
wherein the operation policy includes a requirement for a link in the second layer; and
wherein, in the process of generating the topology in the second layer, the topology in the second layer is generated by selecting paths satisfying the requirement included in the operation policy from the paths in the first layer forming the links in the second layer to which the requirement is directed.

### <Mode 22>

The program according to mode 20 or 21;
wherein, in the process of generating the topology in the second layer, the topology in the second layer is generated by aggregating a plurality of paths in the first layer forming the links in the second layer.

### <Mode 23>

The program according to any one of modes 20 to 22;
wherein, in the process of generating the topology in the second layer, the topology in the second layer is generated by selecting paths of which of route are different each other as the paths appropriate for the operation policy from the plurality of paths in the first layer forming the links in the second layer.

### <Mode 24>

The program according to any one of modes 20 to 23;
wherein, in the process of generating the topology in the second layer, if the operation policy includes a plurality of requirements for a link in the second layer, topologies in the second layer generated for the plurality of requirements, respectively, are integrated to generate the topology in the second layer for the operation policy including the plurality of requirements.

### <Mode 25>

The program according to mode 24, further causing the computer to execute processes of:
updating a topology in the first layer by adding a path forming a link in the second layer to the topology in the first layer; and
generating the topology in the second layer by using the updated first topology.

### <Mode 26>

The program according to mode 25;
wherein, in the process of updating the topology in the first layer, if paths appropriate for the operation policy including a plurality of requirements cannot be selected by using the integrated topology in the second layer, a path is added to the topology in the first layer.

### <Mode 27>

The program according to any one of modes 19 to 26;
wherein the operation policy includes a requirement for a link in the second layer used when the network provides a service; and
wherein, based on the topology in the second layer, packet handling operations for packets relating to the service are set in communication apparatus belonging to the first layer and/or the second layer.

### <Mode 28>

A communication system comprising the control apparatus according to any one of modes 1 to 9.

The entire disclosure of the above PTL and the like referred to in the description is incorporated herein by reference thereto. Modifications and adjustments of the exemplary embodiments and examples are possible within the scope of the overall disclosure (including the claims) of the present invention and based on the basic technical concept of the present invention. Various combinations and selections of various disclosed elements (including the elements in each of the claims, exemplary embodiments, examples, drawings, etc.) are possible within the scope of the claims of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10, 10-1 to 10-4 edge node
11 communication unit
12 table management unit
13 table database (table DB)
14 forwarding processing unit
20, 100 control apparatus
30 communication terminal
40, 40-1 to 40-9 transport node
141 table search unit
142 action execution unit
201 upper layer management unit
202 lower layer management unit
203 operation management unit
204 upper layer topology generation unit
205 upper layer packet handling operation generation unit
206 lower layer packet handling operation generation unit
207 upper layer management database (upper layer management DB)
208 lower layer management database (lower layer management DB)
209 operation policy database (operation policy DB)
210 upper layer topology database (upper layer topology DB)
211 upper layer packet handling operation database (upper layer packet handling operation DB)
212 lower layer packet handling operation database (lower layer packet handling operation DB)
213 node communication unit

What is claimed is:

1. A control apparatus, controlling a hierarchized network and generating a topology in a second layer different from a first layer based on an operation policy for the network and paths in the first layer of the network.

2. The control apparatus according to claim 1;
wherein the topology in the second layer is generated by selecting paths appropriate for the operation policy from the paths in the first layer forming links in the second layer.

3. The control apparatus according to claim 2;
wherein the operation policy includes a requirement for a link in the second layer; and
wherein the topology in the second layer is generated by selecting paths satisfying the requirement included in the operation policy from the paths in the first layer forming the links in the second layer to which the requirement is directed.

4. The control apparatus according to claim 2;
wherein the topology in the second layer is generated by aggregating a plurality of paths in the first layer forming the links in the second layer.

5. The control apparatus according to claim 2;
wherein the topology in the second layer is generated by selecting paths whose routes are disjoint as the paths appropriate for the operation policy from the plurality of paths in the first layer forming the links in the second layer.

6. The control apparatus according to claim 2;
wherein, if the operation policy includes a plurality of requirements for a link in the second layer, topologies in the second layer generated for the plurality of requirements, respectively, are integrated to generate the topology in the second layer for the operation policy including the plurality of requirements.

7. The control apparatus according to claim 6;
wherein the topology in the second layer is generated by adding a path forming a link in the second layer to a topology in the first layer, updating the topology in the first layer, and using the updated topology in the first layer.

8. The control apparatus according to claim 7;
wherein, if paths appropriate for the operation policy including a plurality of requirements cannot be selected by using the integrated topology in the second layer, a path is added to the topology in the first layer.

9. The control apparatus according to claim 1;
wherein the operation policy includes a requirement for a link in the second layer used when the network provides a service; and
wherein, based on the topology in the second layer, packet handling operations for packets relating to the service are set in a communication apparatus belonging to the first layer and/or the second layer.

10. A method of controlling a control apparatus controlling a hierarchized network, the method comprising:
receiving an operation policy for the network; and
generating a topology in a second layer different from a first layer based on the operation policy and paths in the first layer in the network.

11. The method of controlling the control apparatus according to claim 10;
wherein, in generating the topology in the second layer, the topology in the second layer is generated by selecting paths appropriate for the operation policy from the paths in the first layer forming links in the second layer.

12. The method of controlling the control apparatus according to claim 11;
wherein the operation policy includes a requirement for a link in the second layer; and
wherein, in generating the topology in the second layer, the topology in the second layer is generated by selecting paths satisfying the requirement included in the operation policy from the paths in the first layer forming the links in the second layer to which the requirement is directed.

13. The method of controlling the control apparatus according to claim 11;
wherein, in the step of generating the topology in the second layer, the topology in the second layer is generated by aggregating a plurality of paths in the first layer forming the links in the second layer.

14. The method of controlling the control apparatus according to claim 11;
wherein, in generating the topology in the second layer, the topology in the second layer is generated by selecting paths whose routes are disjoint as the paths appropriate for the operation policy from the plurality of paths in the first layer forming the links in the second layer.

15. The method of controlling the control apparatus according to claim 11;
wherein, in generating the topology in the second layer, if the operation policy includes a plurality of requirements for a link in the second layer, topologies in the second layer generated for the plurality of requirements, respectively, are integrated to generate the topology in the second layer for the operation policy including the plurality of requirements.

16. The method of controlling the control apparatus according to claim 15; further comprising:
updating a topology in the first layer by adding a path forming a link in the second layer to the topology in the first layer; and
generating the topology in the second layer by using the updated first topology.

17. The method of controlling the control apparatus according to claim 16;
wherein, in updating the topology in the first layer, if paths appropriate for the operation policy including a plurality of requirements cannot be selected by using the integrated topology in the second layer, a path is added to the topology in the first layer.

18. The method of controlling the control apparatus according to claim 10;
wherein the operation policy includes a requirement for a link in the second layer used when the network provides a service; and
wherein, based on the topology in the second layer, packet handling operations for packets relating to the service are set in a communication apparatus belonging to the first layer and/or the second layer.

19. A non-transitory computer-readable recording medium storing a program causing a computer, which constitutes a control apparatus that controls a hierarchized network, to execute processes of:
receiving an operation policy for the network; and
generating a topology in a second layer different from a first layer based on the operation policy and paths in the first layer in the network.
